(19) United States
(12) Patent Application Publication
(10) Pub. No.: US 2011/0076605 A1
(43) Pub. Date: Mar. 31, 2011

(54) ELECTROPHOTOGRAPHIC PHOTORECEPTOR, METHOD FOR PRODUCING ELECTROPHOTOGRAPHIC PHOTORECEPTOR, PROCESS CARTRIDGE AND IMAGE FORMING APPARATUS

(75) Inventors: Takatsugu DOI, Kanagawa (JP); Wataru YAMADA, Kanagawa (JP); Akira HIRANO, Tokyo (JP); Katsumi NUKADA, Kanagawa (JP)

(73) Assignee: FUJI XEROX CO., LTD., TOKYO (JP)

(21) Appl. No.: 12/724,129

(22) Filed: Mar. 15, 2010

(30) Foreign Application Priority Data
Sep. 25, 2009 (JP) 2009-221349

(51) Int. Cl. G03G 5/07; G03G 5/04

(52) U.S. Cl. 430/58.7; 430/58.05; 430/130

(57) ABSTRACT

An electrophotographic photoreceptor includes an electroconductive substrate and a photosensitive layer formed thereon, the photosensitive layer including a sub-layer that constitutes an outermost surface of the photosensitive layer, the sub-layer including an organic solvent having a boiling point of from about 65° C. to about 250° C. in an amount of from about 5,000 ppm to about 50,000 ppm, and the sub-layer including a polymer of a charge transporting material having a polymerizable group.

This application is based on and claims priority under 35 USC 119 from Japanese Patent Application No. 2009-221349 filed on Sep. 25, 2009.

### BACKGROUND

1. Technical Field

The present invention relates to an electrophotographic photoreceptor, a method for producing an electrophotographic photoreceptor, a process cartridge and an image forming apparatus.

2. Related Art

In an electrophotographic image forming apparatus, the surface of an electrophotographic photoreceptor is charged by a charger, the charged surface of the electrophotographic photoreceptor is selectively removed of charge by exposure to light to form an electrostatic latent image, and a toner is adhered to the electrostatic latent image using a developing apparatus to develop the latent image as a toner image. The toner image is transferred onto an image receiving medium by a transfer apparatus, then the toner image is ejected as an image-formed product.

Providing a protective layer on the surface of the electrophotographic photoreceptor has been proposed.

Recently, a protective layer made of an acrylic material has been receiving attention. These acrylic materials are strongly affected by curing conditions, an atmosphere which promotes curing, and the like.

### SUMMARY

According to a first aspect of the present invention, there is provided an electrophotographic photoreceptor comprising an electroconductive substrate and a photosensitive layer formed thereon, the photosensitive layer comprising a sub-layer that constitutes an outermost surface of the photosensitive layer,

the sub-layer comprising an organic solvent having a boiling point of from about 65° C. to about 250° C. in an amount of from about 5,000 ppm to about 50,000 ppm, and

the sub-layer comprising a polymer of a charge transporting material having a polymerizable group.

### BRIEF DESCRIPTION OF THE DRAWINGS

Exemplary embodiments of the present invention will be described in detail based on the following figures, wherein:

FIG. 1 is a schematic partial cross-sectional drawing showing an exemplary embodiment of the electrophotographic photoreceptor of the invention;

FIG. 2 is a schematic partial cross-sectional drawing showing another exemplary embodiment of the electrophotographic photoreceptor of the invention;

FIG. 3 is a schematic cross-sectional drawing of a process cartridge of an exemplary embodiment of the invention;

FIG. 4 is a schematic cross-sectional drawing of a tandem-type image forming apparatus of an exemplary embodiment of the invention; and

FIGS. 5A to 5C are drawings showing the criteria for ghost image evaluation.

### DETAILED DESCRIPTION

Hereinafter exemplary embodiments of the invention are described in detail.

Electrophotographic Photoreceptor

An electrophotographic photoreceptor according to an exemplary embodiment of the invention at least has an electroconductive substrate and a photosensitive layer formed thereon, in which the photosensitive layer has a sub-layer which constitutes the outermost surface of the photosensitive layer (hereinafter simply referred to as “outermost layer”), the outermost layer at least contains an organic solvent having a boiling point of from 65° C. to 250° C. or from about 65° C. to about 250° C. in an amount of from 5,000 ppm to 50,000 ppm or from about 5,000 ppm to about 50,000 ppm, and a polymer of a charge transporting material having a polymerizable group.

The “photosensitive layer” as used herein at least includes a charge generating layer and a charge transporting layer.

In an image forming apparatus, a so-called discharge product having strong oxidizing property is generated from a non-contact type charger such as a corona discharger or a contact type charger such as a charging roll. Previously, the surface of the photoreceptor was sometimes deteriorated (so-called deletion) by oxidation of the surface of the photoreceptor by the discharge product or adhesion of ion species.

Although the mechanism for obtaining an effect whereby deterioration (deletion), due to the discharge product, is suppressed by the electrophotographic photoreceptor of the exemplary embodiment is not necessarily clear, it is presumed as follows. In the electrophotographic photoreceptor of the exemplary embodiment, the outermost layer contains an organic solvent in an amount of from 5,000 ppm to 50,000 ppm. It is thought that the organic solvent included in the outermost layer which may be formed by polymerizing the charge transporting material having a polymerizable group, bleeds out of the surface of the photoreceptor, whereby an effect of preventing deterioration of the photoreceptor due to the discharge product generated from the charger is obtained.

Meanwhile, it is expected that, when the organic solvent remains in a photoreceptor (i.e., a non-curable photoreceptor) other than the photoreceptor having a polymerization-curable outermost layer which may be formed by polymerizing a charge transporting material having a polymerizable group, the resin swells and the mechanical strength may not be retained. Therefore, the technique of leaving an organic solvent in the outermost layer of a photosensitive layer is an effective technique in a photoreceptor having the above-mentioned polymerization-curable outermost layer in which the resin does not swell.

Furthermore, when the amount of the organic solvent in the outermost layer is from 5,000 ppm to 50,000 ppm, an effect whereby the mechanical strength of the outermost layer is increased may also be obtained.

Although the mechanism for obtaining this effect is not necessarily clear, it is expected to relate to the flowability of the coating film during polymerization. Namely, it is thought that the higher the flowability of the coating film is, the more active the molecular mobility in the coating film is during polymerization, and thus the polymerizable groups are readily polymerized by each other. Therefore, it is expected that a mechanical strength is obtained because the organic solvent remains in the coating film during heat polymerization and maintains the flowability of the coating film.

Amount of Organic Solvent

As mentioned above, the amount of the organic solvent in the outermost layer is from 5,000 ppm to 50,000 ppm (or about from 5,000 ppm to about 50,000 ppm), more preferably from 5,000 ppm to 25,000 ppm (or from about 5,000 ppm to about 25,000 ppm), and particularly preferably from 10,000 ppm to 25,000 ppm (or from about 10,000 ppm to about 25,000 ppm).

When the amount is less than 5,000 ppm, bleeding of the organic solvent on the surface of the photoreceptor is small, and deterioration (deletion) due to the discharge product is not suppressed. On the other hand, when the amount of the organic solvent in the outermost layer is more than 50,000 ppm, the crosslinking density is decreased, and the mechanical strength is decreased.

The amount of the organic solvent having a boiling point of from 65° C. to 250° C. in the outermost layer is measured by the following method, and the values described in the present specification were measured by the method.

A predetermined amount of the outermost layer is measured and immersed in organic solvents (2 types). The immersed outermost layer is shaken in a shaker to extract the organic solvents remaining in the outermost layer. The thus-obtained liquid is put in an LC/MS apparatus to identify the solvent species. Furthermore, standard curves are respectively prepared for the identified solvents using HPLC, and the amounts of the solvents in the above-mentioned extracted liquid are measured using the standard curves.

Boiling Point of Organic Solvent

As mentioned above, the boiling point of the organic solvent in the outermost layer is from 65° C. to 250° C. (or from about 65° C. to about 250° C.), more preferably from 150° C. to 250° C. (from about 150° C. to about 250° C.), and particularly preferably from 160° C. to 230° C. (from about 160° C. to about 230° C.).

Although conventionally-used organic solvents having a boiling point of 65° C. or more may be used as the organic solvent, the boiling point is more preferably 150° C. or more, and particularly preferably 160° C. or more, in view of suppression of evaporation of the organic solvent over time and suppression of deterioration of the photoreceptor for a long time period. On the other hand, when the boiling point of the organic solvent exceeds 250° C., mechanical strength is decreased. This is because a large amount of the solvent remains during polymerization, whereby the possibility of polymerization is decreased and crosslinking becomes insufficient.

The boiling point of the organic solvent may be measured by the following method. Specifically, a measurement sample is subjected to a GC/MS (Gas Chromatography Mass Spectrometer) apparatus to identify volatile components included in the measurement sample, and a boiling point is derived.

It is preferable that the boiling point of the organic solvent in the outermost layer is higher than the decomposition temperature of the polymerization initiator contained in the outermost layer, and the difference between the boiling point of the organic solvent and the decomposition temperature of the polymerization initiator is more than 0° C. and 125° C. or less (o more than about 0° C. and about 125° C. or less), more preferably more than 0° C. and 90° C. or less (or more than about 0° C. and about 90° C. or less), and particularly preferably from 50° C. to 90° C. (from about 50° C. to about 90° C.).

When the boiling point of the organic solvent is higher than the decomposition temperature of the polymerization initiator, sufficient mechanical strength is obtained. Furthermore, when the difference between the boiling point of the organic solvent and the decomposition temperature of the polymerization initiator is 125° C. or less, a photoreceptor having excellent electrical properties may be obtained.

The decomposition temperature of the polymerization initiator may be measured by the following method, and the values described in the present specification are measured by the method. Specifically, a measurement sample is subjected to an MS apparatus to identify the terminal structure included in the measurement sample, whereby the structure of the polymerization initiator is defined, and the decomposition temperature is derived from the structure.

Number of Polymerizable Groups Included in Charge Transporting Material

The number of the polymerizable group(s) included in the charge transporting material having a polymerizable group is preferably 2 or more, and more preferably 4 or more. When the number of the polymerizable group included in the charge transporting material which is used for forming the outermost layer is 2 or more, a photoreceptor having excellent mechanical strength is obtained.

Relationship Between Temperature for Heat Polymerization and Boiling Point of Organic Solvent

In the production of the electrophotographic photoreceptor of an exemplary embodiment of the invention, the outermost layer may be formed by applying a solution (coating liquid) containing at least the organic solvent having a boiling point of from 65° C. to 250° C. or from about 65° C. to about 250° C. and the charge transporting material having a polymerizable group, and heat polymerizing the solution. In such a method, the heat polymerization may be performed at a temperature of −30° C. to 30° C. or about −30° C. to about 30° C. relative to the boiling point of the organic solvent.

When the temperature for heat polymerization is in the range of from −30° C. to 30° C. relative to the boiling point of the organic solvent, an outermost layer having excellent strength may be obtained.

The “temperature for heat polymerization” refers to the temperature at the surface of the photoreceptor during heat polymerization.

Half-Life Temperature of Heat Polymerization Initiator

As mentioned above, in the production of the electrophotographic photoreceptor of the exemplary embodiment, the outermost layer is formed by applying the above-mentioned solution (coating liquid) and heat polymerizing the solution. During the production, it is preferable that the solution further contains a heat polymerization initiator, and that the amount of the heat polymerization initiator contained in the solution decreases by half after being left for 10 hours (or about 10 hours) at a temperature (half-life temperature) of from 10° C. to 100° C. (or from about 10° C. to about 100° C.).

The “temperature at which the amount of the polymerization initiator decreases by half after being left for 10 hours” refers to a temperature at which a half amount of the polymerization initiator is decomposed after being left for 10 hours.

When the half-life temperature of the heat polymerization initiator is 10° C. or more, an outermost layer having excellent electrical properties may be formed. When the half-life temperature of the heat polymerization initiator is 100° C. or less, an outermost layer having excellent mechanical strength may be formed.

Hereinafter, electrophotographic photoreceptors according to exemplary embodiments of the invention will be described by referring to the drawings. In the drawings, the identical parts or corresponding parts will be assigned with identical symbols, and overlapping explanations will be omitted.

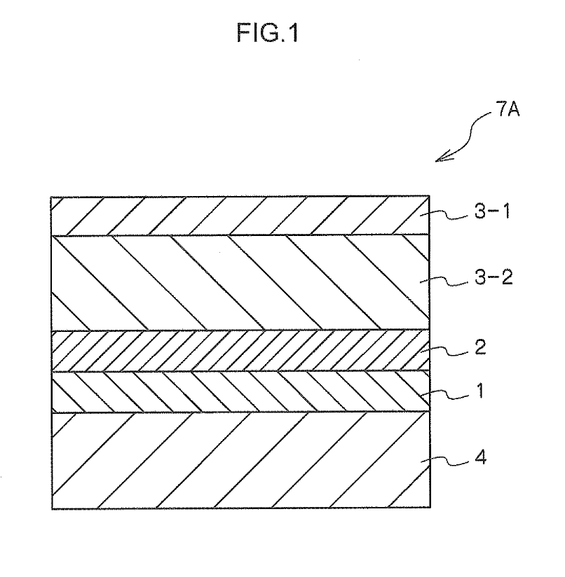

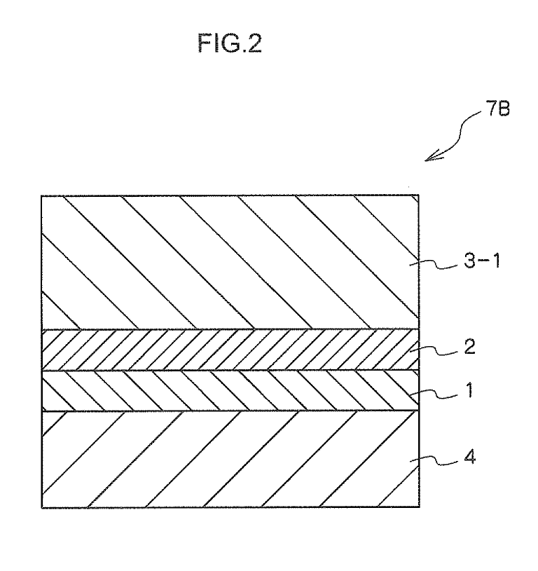

FIGS. 1 and 2 are schematic partial cross-sectional drawings which respectively show examples of the electrophotographic photoreceptor of the exemplary embodiments of the invention.

In FIG. 1, undercoating layer 1 is provided on electroconductive substrate 4, and charge generating layer 2 and charge transporting layers 3-1 and 3-2 consisting of two layers are further provided thereon. In electrophotographic photoreceptor 7A shown in FIG. 1, the outermost layer refers to charge transporting layer 3-1.

In FIG. 2, undercoating layer 1 is provided on electroconductive substrate 4, and charge generating layer 2 and charge transporting layer 3-1 consisting of one layer are further provided thereon. In electrophotographic photoreceptor 7B shown in FIG. 2, the outermost layer refers to charge transporting layer 3-1.

In other exemplary embodiments, electrophotographic photoreceptors 7A and 7B shown in FIGS. 1 and 2 may not have undercoating layer 1, respectively.

Hereinafter, the respective layers are described in detail by referring to the structure of electrophotographic photoreceptor 7A shown in FIG. 1 as a representative example.

Outermost Layer or Charge Transporting Layer 3-1

First, charge transporting layer 3-1, which is the outermost layer, is described.

Charge transporting layer 3-1, which is the outermost layer of electrophotographic photoreceptor 7A of the exemplary embodiment, contains at least a polymer of a charge transporting material having a polymerizable group.

Any material may be used as long as it is a charge transporting material having a polymerizable group, and examples of the polymerizable group include a methacryl group, an acryl group and a styryl group, and derivatives thereof.

The charge transporting material having a polymerizable group is preferably a compound having a triphenylamine backbone and two or more polymerizable groups in a molecule thereof. Specifically, it is preferable to use at least one compound selected from the group consisting of the compounds shown by the following Formula (A).

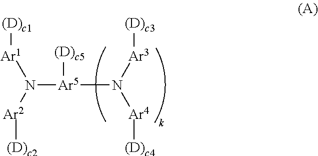

In Formula (A), Ar¹ to Ar⁴ each independently represent a substituted or unsubstituted aryl group; Ar⁵ represents a substituted or unsubstituted aryl group or a substituted or unsubstituted arylene group; D represents —(CH₂)_{d}—(O—(CH₂)_{f})ₑ—O—CO—C(R)—CH₂, wherein R′ represents a hydrogen atom or —CH₃; c1 to c5 each independently represent an integer of from 0 to 2; k represents 0 or 1; d represents an integer of from 0 to 5; f represents an integer of from 1 to 5; e represents 0 or 1; and the total number of the groups represented by D is 2 or more (i.e., the sum of the numbers represented by c1 to c5 is 2 or more).

In Formula (A), Ar¹ to Ar⁴ each independently represent a substituted or unsubstituted aryl group. Ar¹ to Ar⁴ may be the same as or different from one another.

Examples of the substituent other than D: —(CH₂)_{d}—(O—(CH₂)_{f})ₑ—O—CO—C(R)—CH₂ for the substituted aryl group include an alkyl or alkoxy group having 1 to 4 carbon atoms, and a substituted or unsubstituted aryl group having 6 to 10 carbon atoms.

It is preferable that Ar¹ to Ar⁴ each represent any of the following Formulas (1) to (7). The following Formulas (1) to (7) are shown together with “-(D)_{c}” which generically represents “-(D)_{c1}” to “-(D)_{c4}” which may be respectively linked to Ar¹ to Ar⁴.

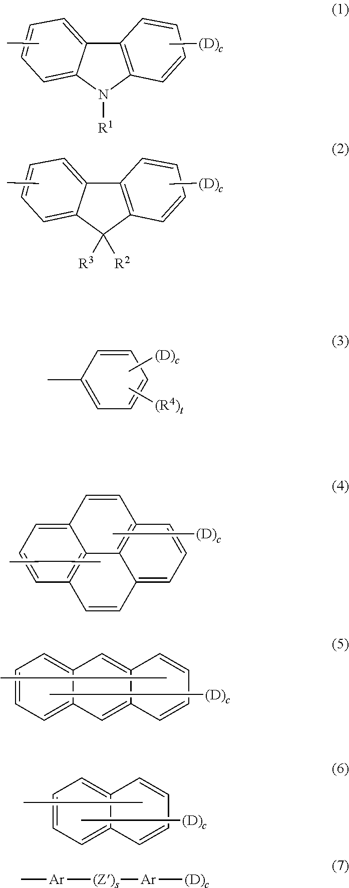

In Formulas (1) to (7), R¹ represents one selected from the group consisting of a hydrogen atom, an alkyl group having 1 to 4 carbon atoms, a phenyl group substituted by an alkyl group having 1 to 4 carbon atoms or an alkoxy group having 1 to 4 carbon atoms, an unsubstituted phenyl group, and an aralkyl group having 7 to 10 carbon atoms; R² to R⁴ each independently represent one selected from the group consisting of a hydrogen atom, an alkyl group having 1 to 4 carbon atoms, an alkoxy group having 1 to 4 carbon atoms, a phenyl group substituted by an alkoxy group having 1 to 4 carbon atoms, an unsubstituted phenyl group, an aralkyl group having 7 to 10 carbon atoms, and a halogen atom; Ar represents a substituted or unsubstituted arylene group; Z′ represents a bivalent organic linking group; D represents —(CH₂)_{d}—(O—(CH₂)_{f})ₑ—O—CO—C(R′)═CH₂ (wherein R′ represents a hydrogen atom or —CH₃, d represents an integer of from 0 to 5, f represents an integer of from 1 to 5, and e represents 0 or 1); c represents 1 or 2; s represents 0 or 1; and t represents an integer of 0 to 3.

The “Ar” shown in the Formula (7) may be any of those represented by the following structural formula (8) or (9).

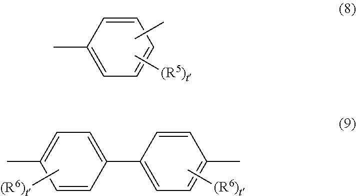

In Formulas (8) and (9), R⁵ and R⁶ each independently represent one selected from the group consisting of a hydrogen atom, an alkyl group having 1 to 4 carbon atoms, an alkoxy group having 1 to 4 carbon atoms, a phenyl group substituted by an alkoxy group having 1 to 4 carbon atoms, an unsubstituted phenyl group, an aralkyl group having 7 to 10 carbon atoms, and a halogen atom; and each t′ represents an integer of from 0 to 3.

In the Formula (7), Z′ represents a bivalent organic linking group, preferably any of the following Formulas (10) to (17). Each s represents 0 or 1.

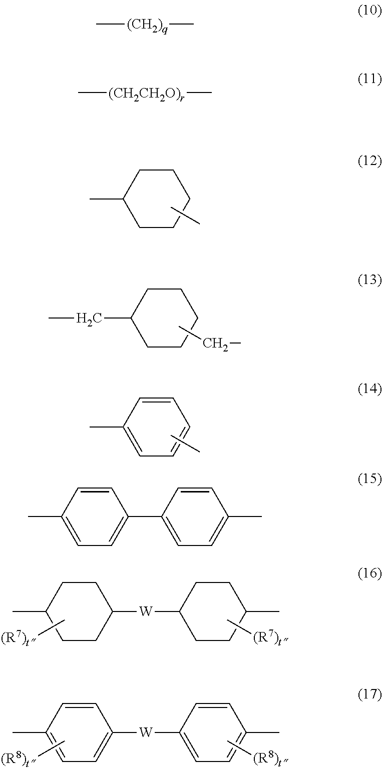

In Formulas (10) to (17), R⁷ and R⁸ each independently represent one selected from the group consisting of a hydrogen atom, an alkyl group having 1 to 4 carbon atoms, an alkoxy group having 1 to 4 carbon atoms, a phenyl group substituted by an alkoxy group having 1 to 4 carbon atoms, an unsubstituted phenyl group, an aralkyl group having 7 to 10 carbon atoms, and a halogen atom; W represents a bivalent group; q and r each independently represent an integer of from 1 to 10, and each t″ represents an integer of from 0 to 3.

It is preferable that W in the Formulas (16) and (17) is any of the bivalent groups represented by the following (18) to (26). In the Formula (25), u represents an integer of from 0 to 3.

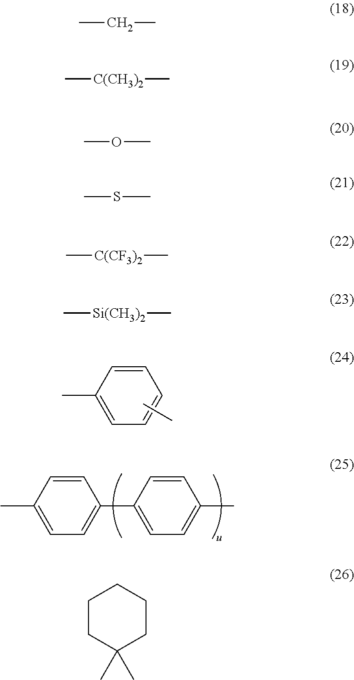

In Formula (A), Ar⁵ represents a substituted or unsubstituted aryl group when k is 0, and examples of the aryl group include the aryl groups as exemplified in the explanation of Ar¹ to Ar⁴. Ar⁵ represents a substituted or unsubstituted arylene group when k is 1, and examples of the arylene group include arylene groups obtained by removing one hydrogen atom from the aryl groups as exemplified in the explanation of Ar¹ to Ar⁴.

In the compound represented by the Formula (A), it is preferable that one or more carbon atoms are present between the charge transporting moiety and the polymerizable group(s). Specifically, the linking group is preferably an alkylene group.

Furthermore, the polymerizable group preferably has a structure having a methacryl group.

Hereinafter, specific examples of the compounds represented by the Formula (A) are shown. However, the compounds represented by the Formula (A) are not limited by these examples.

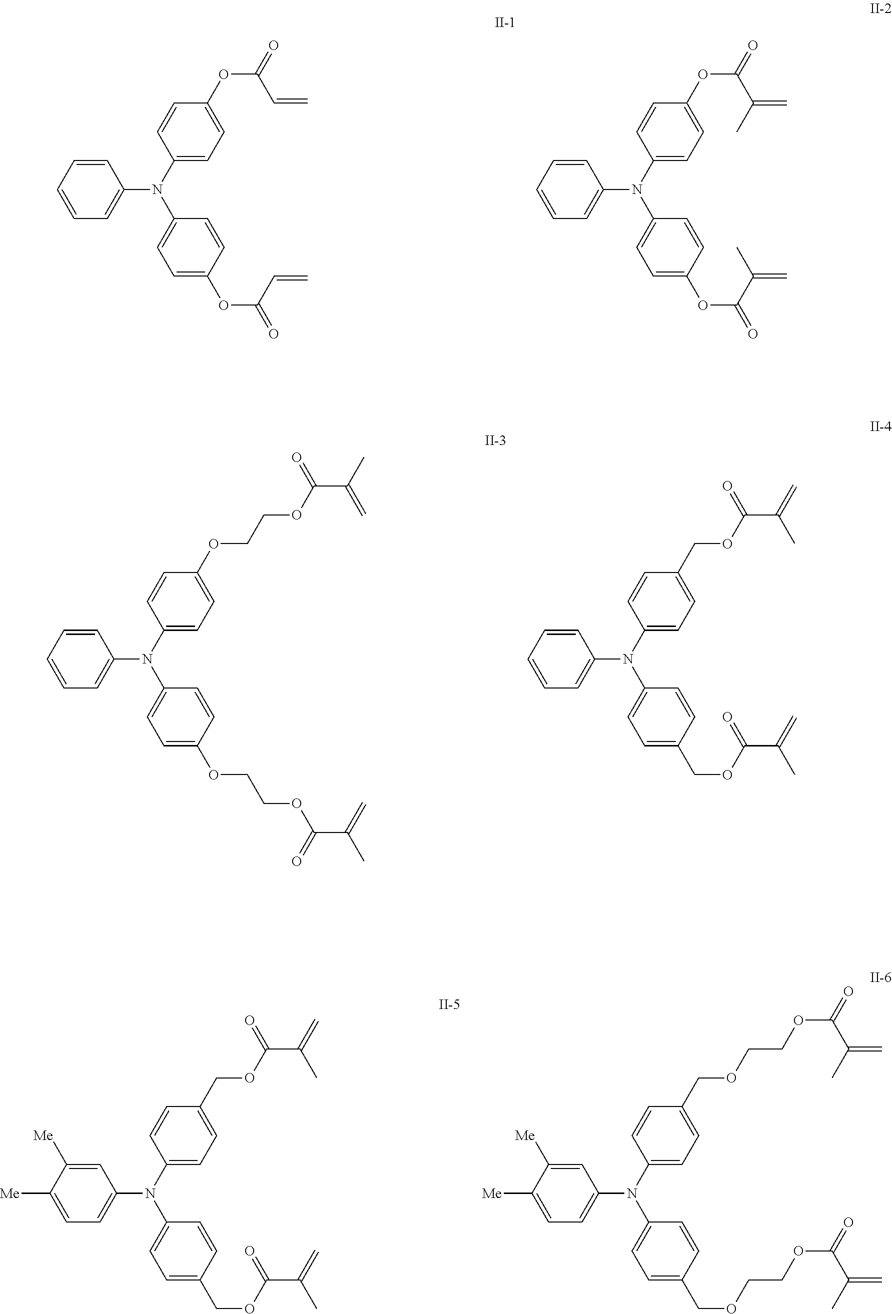

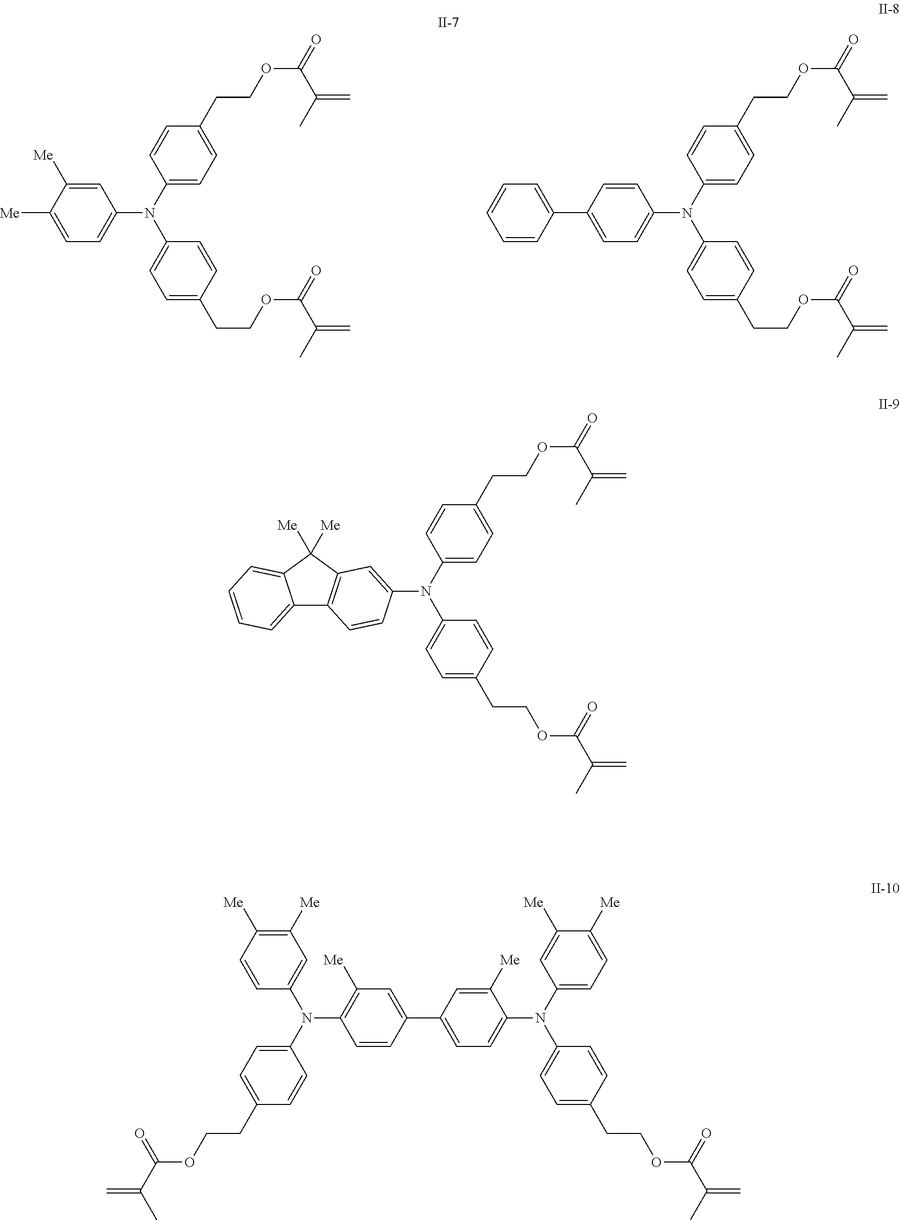

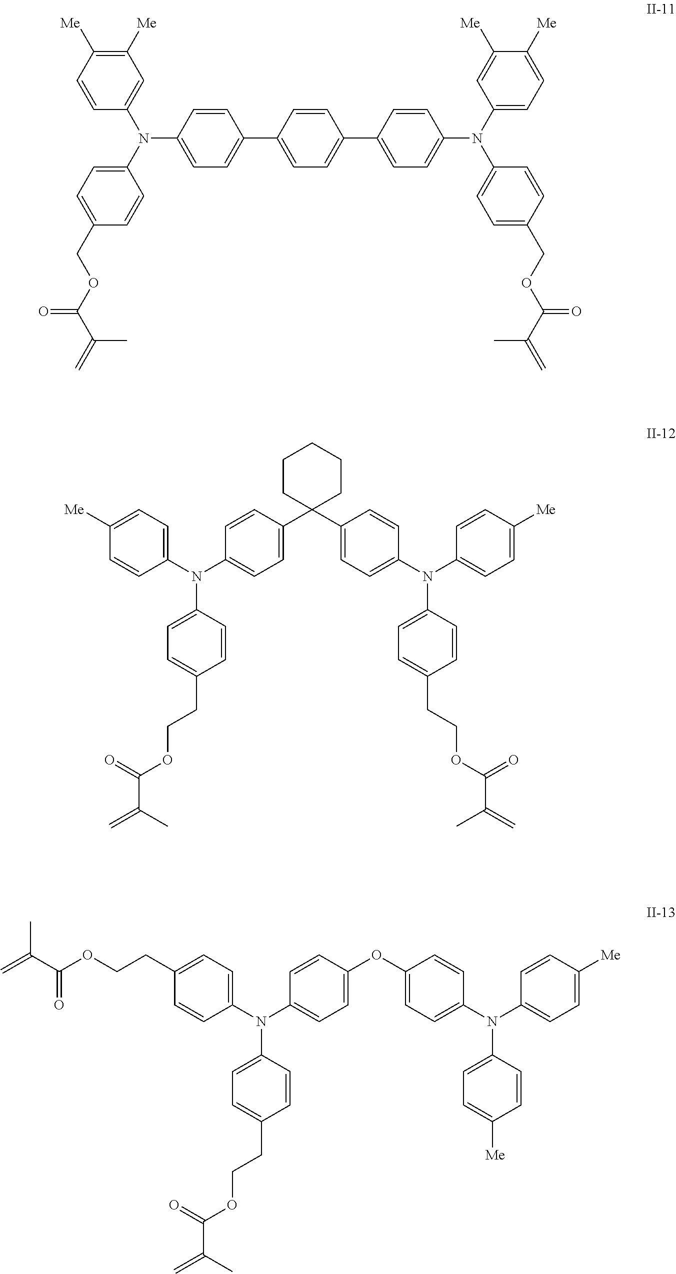

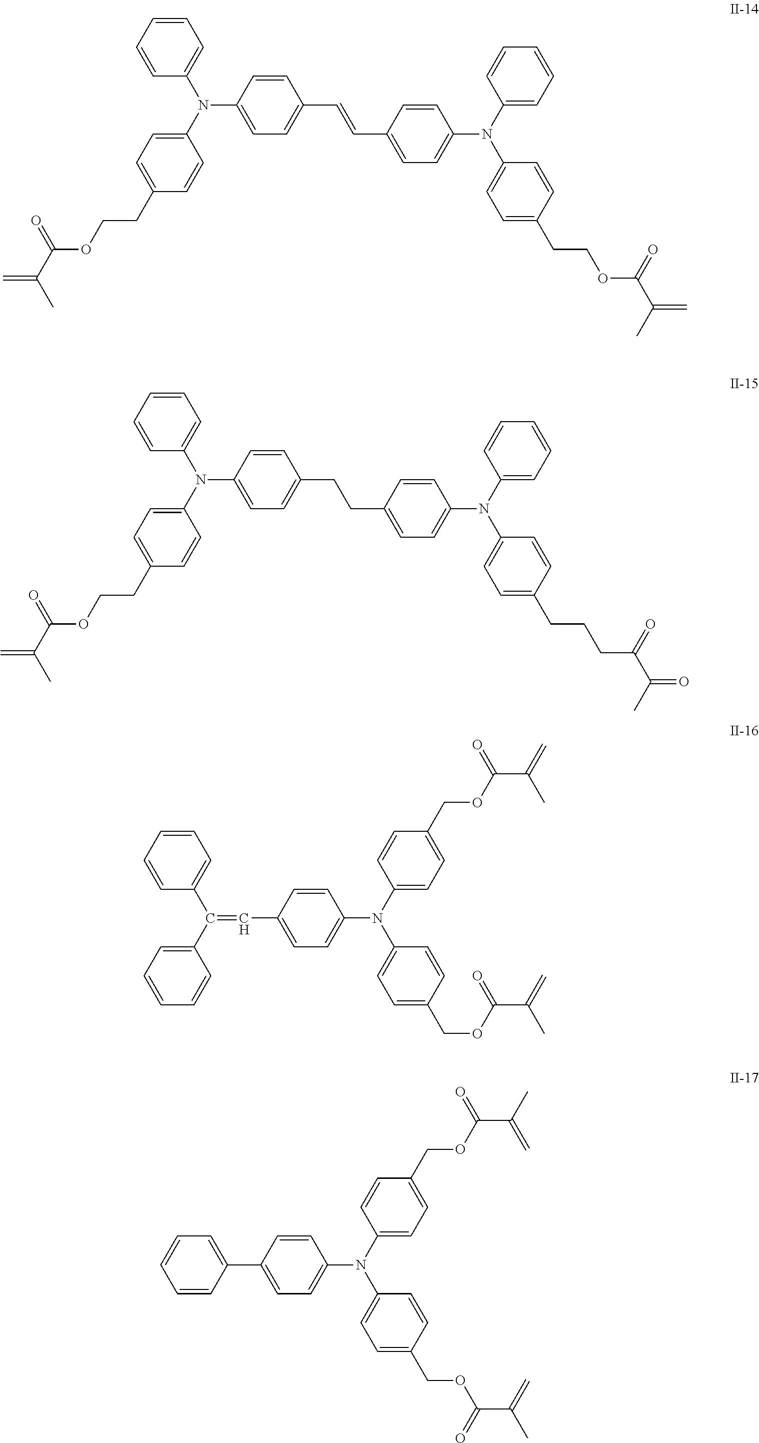

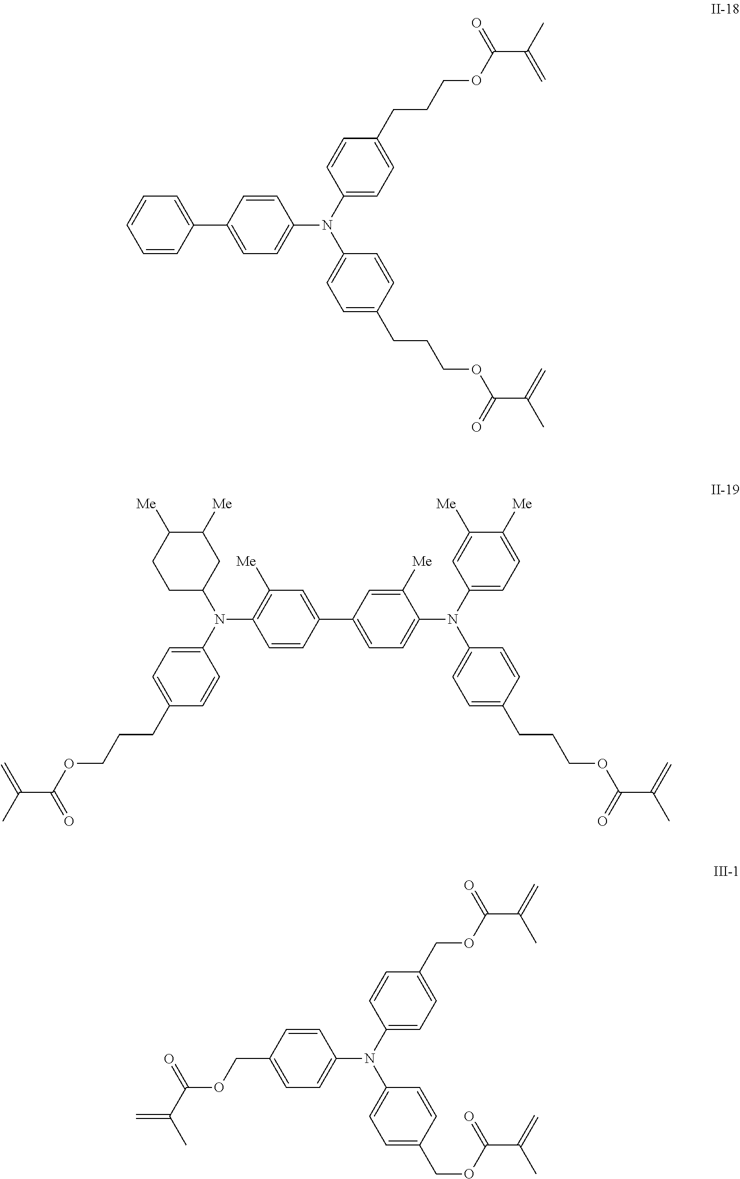

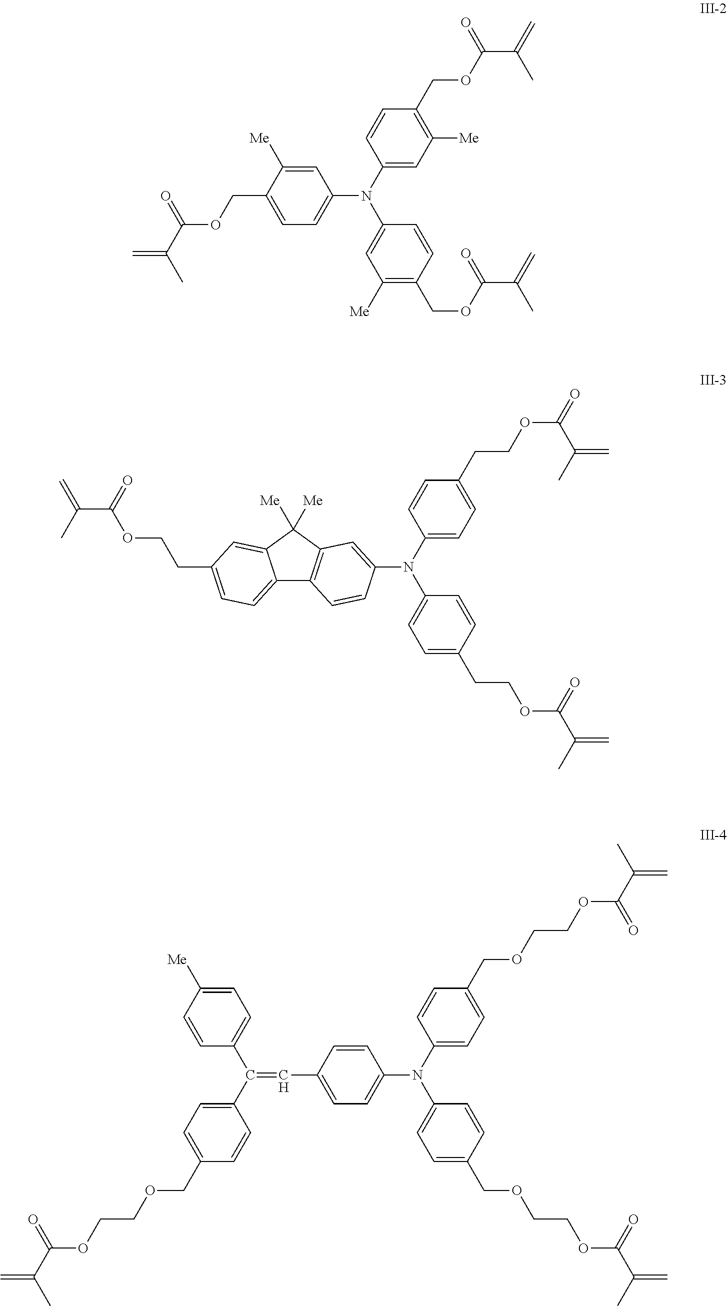

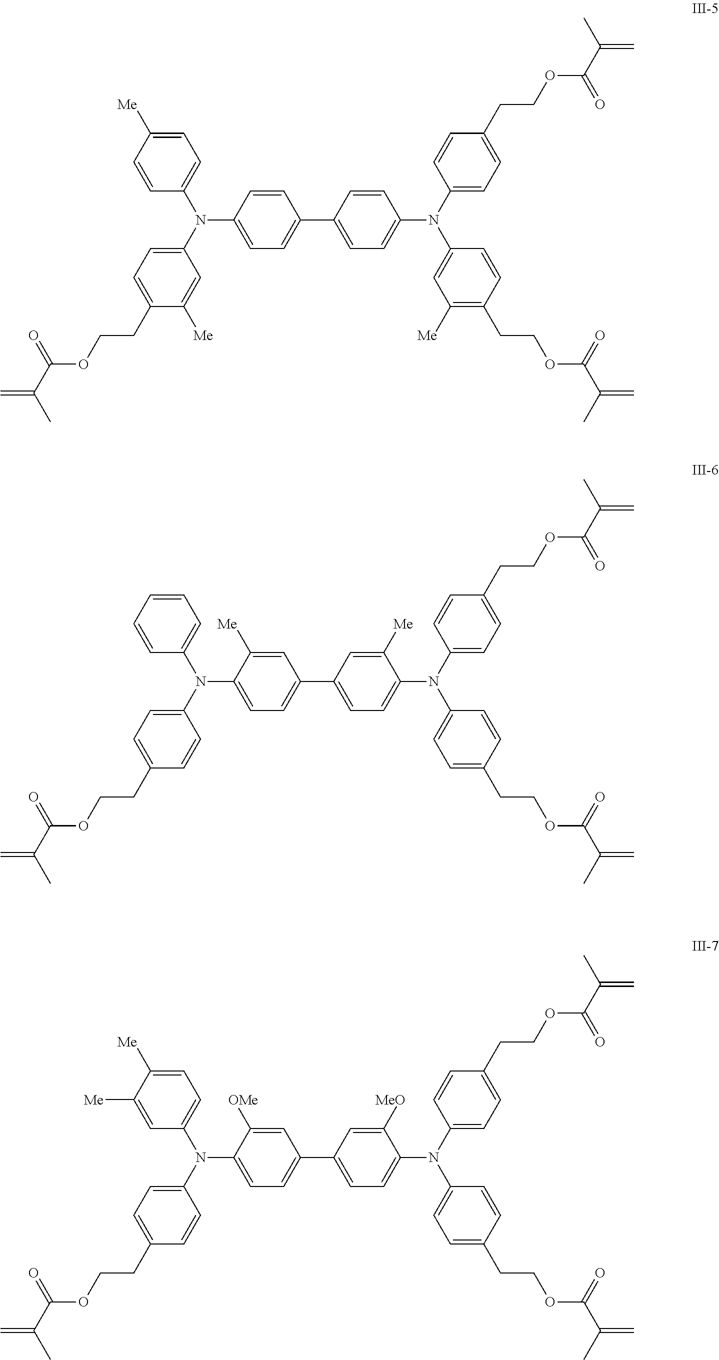

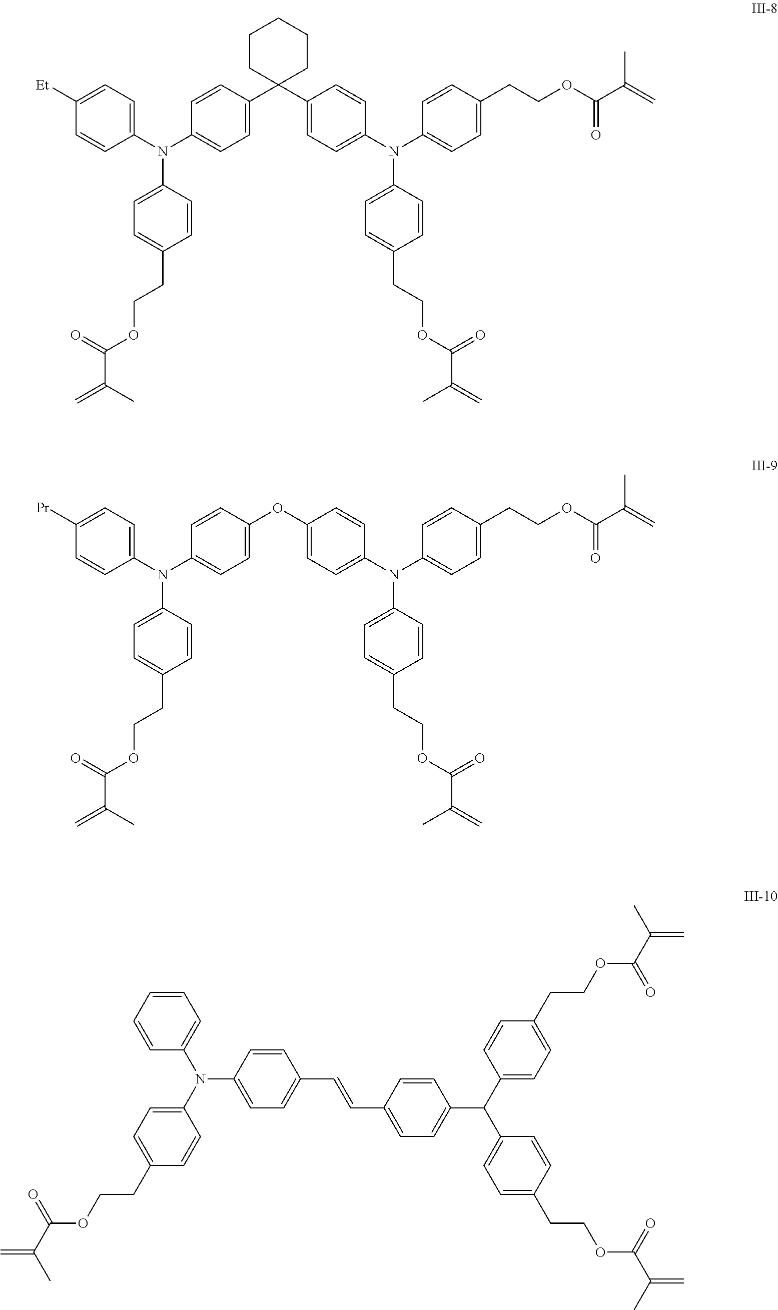

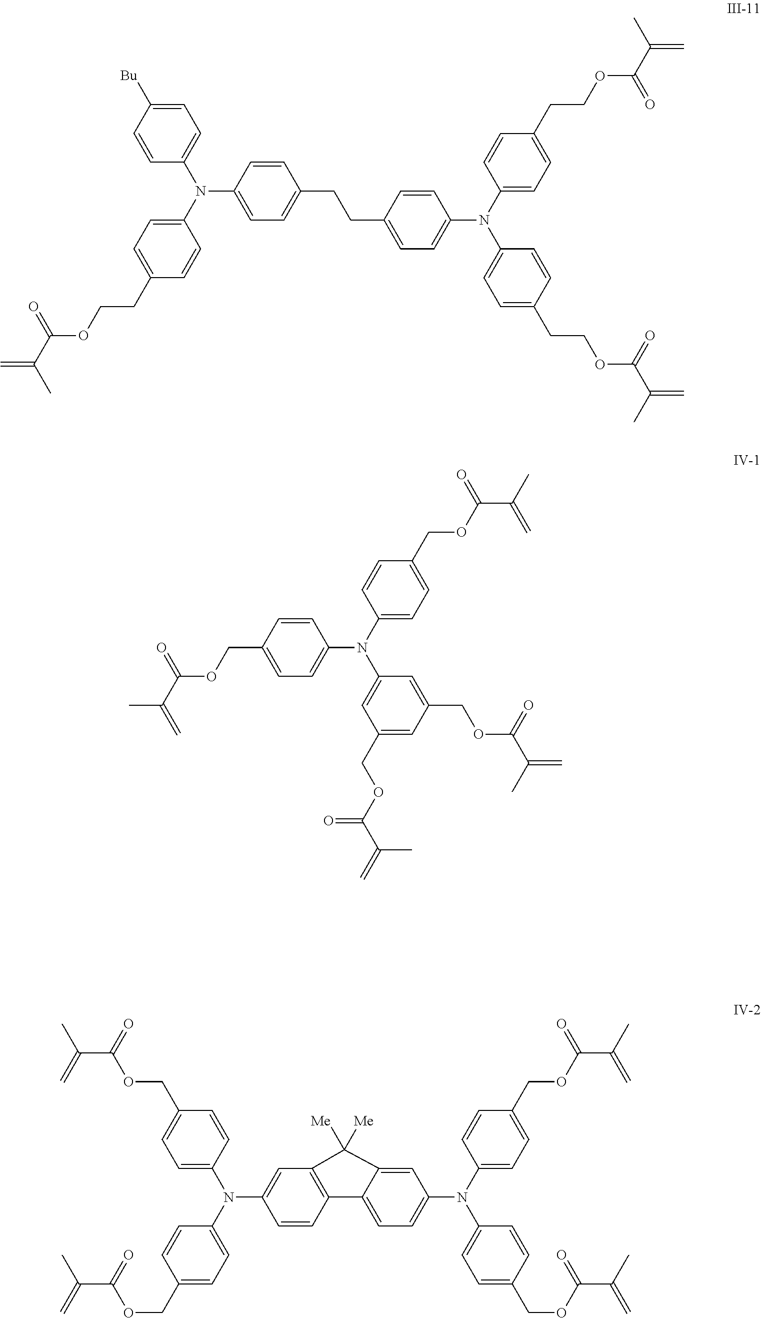

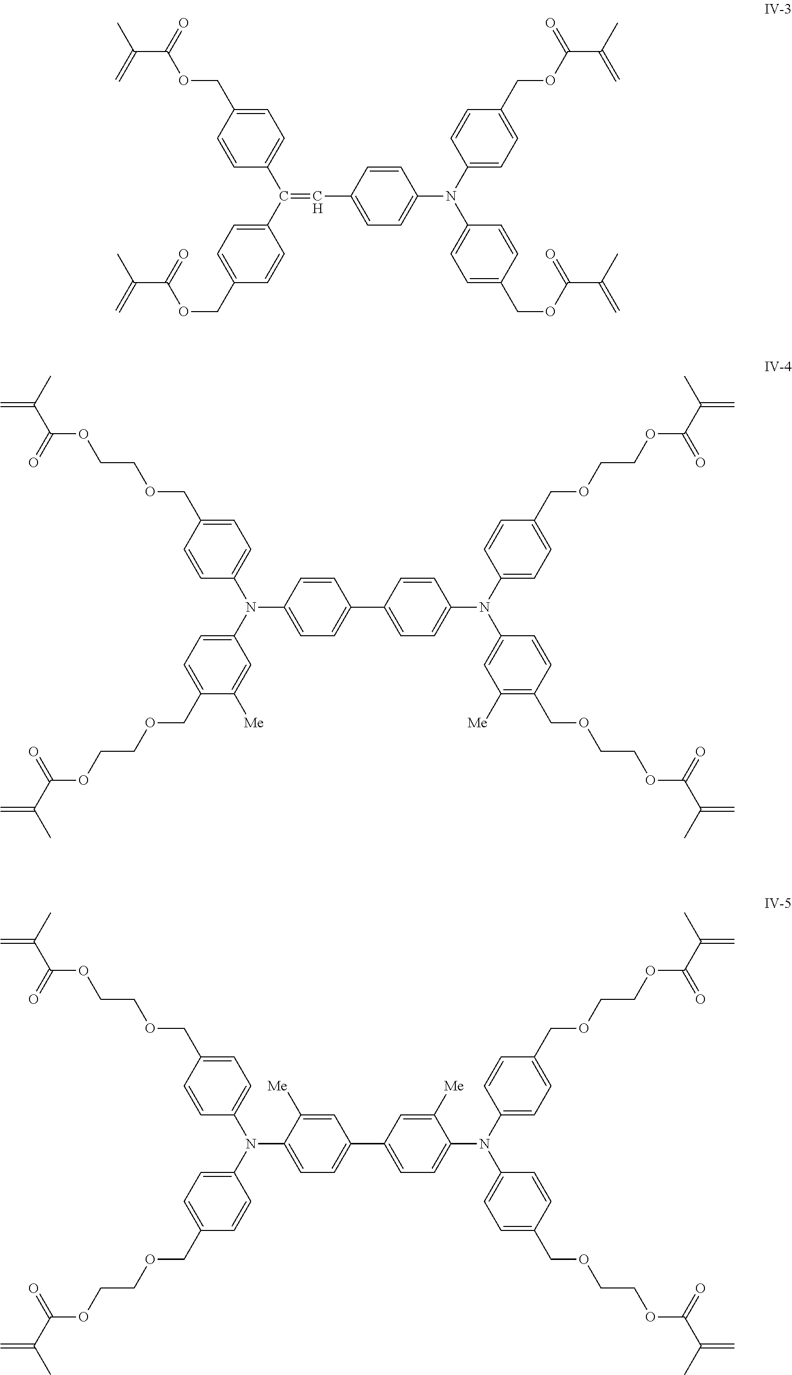

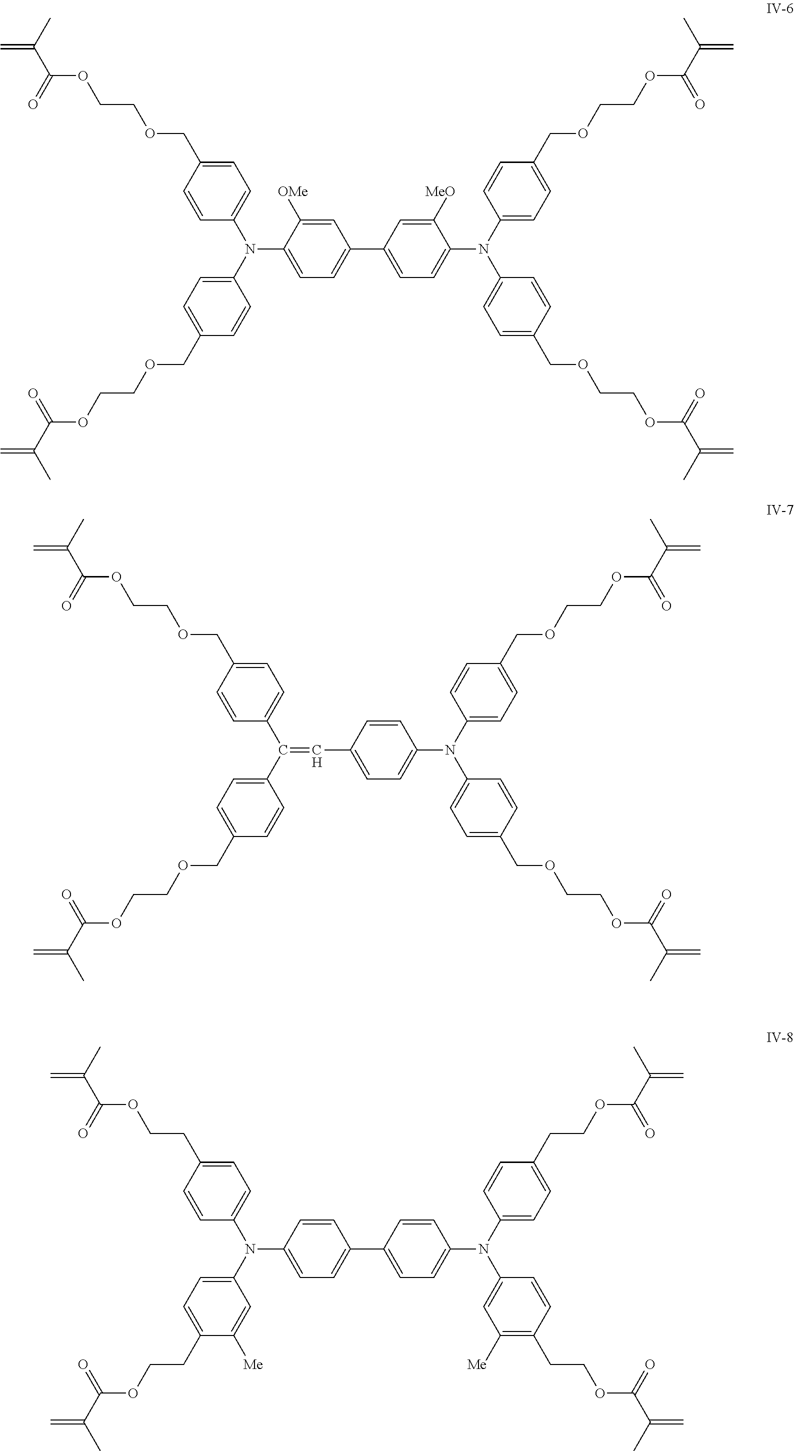

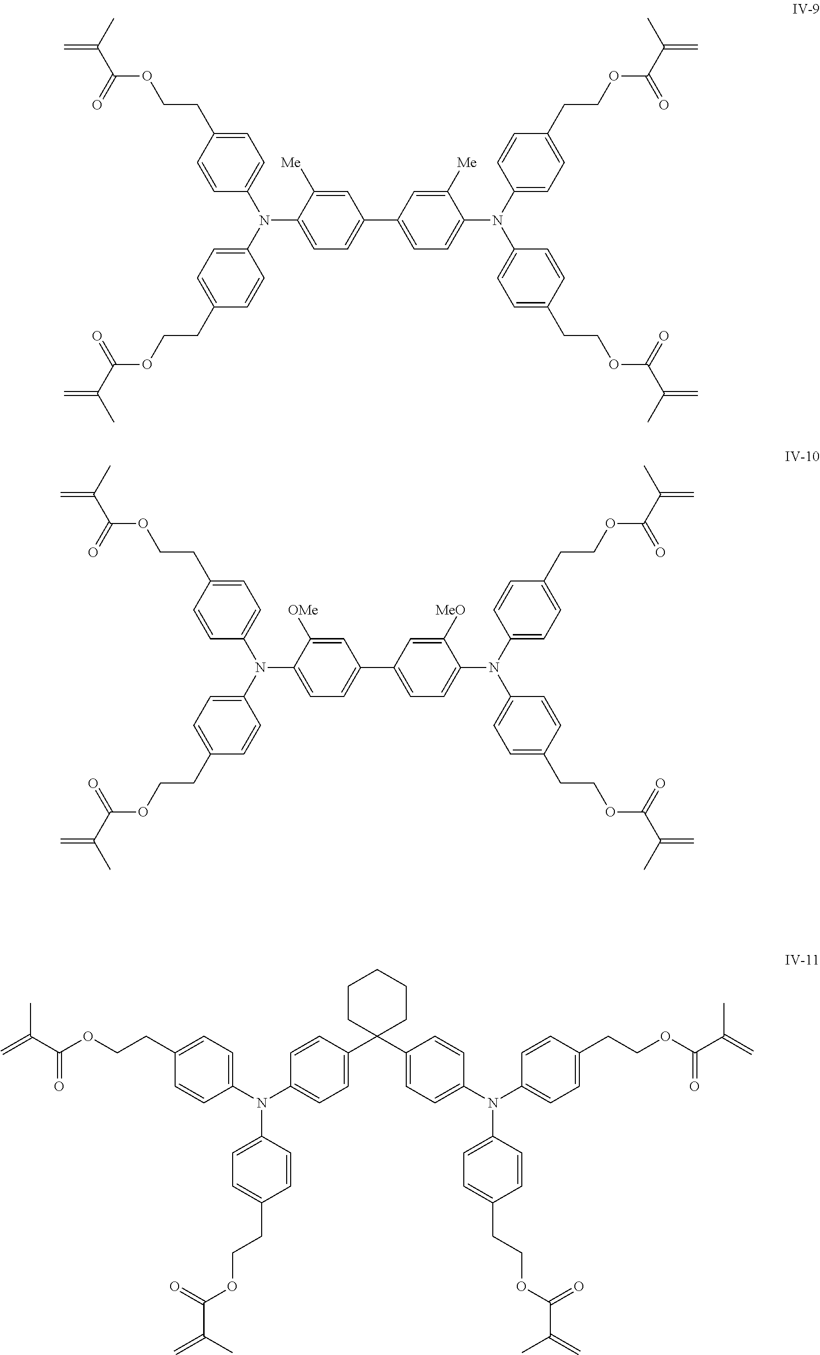

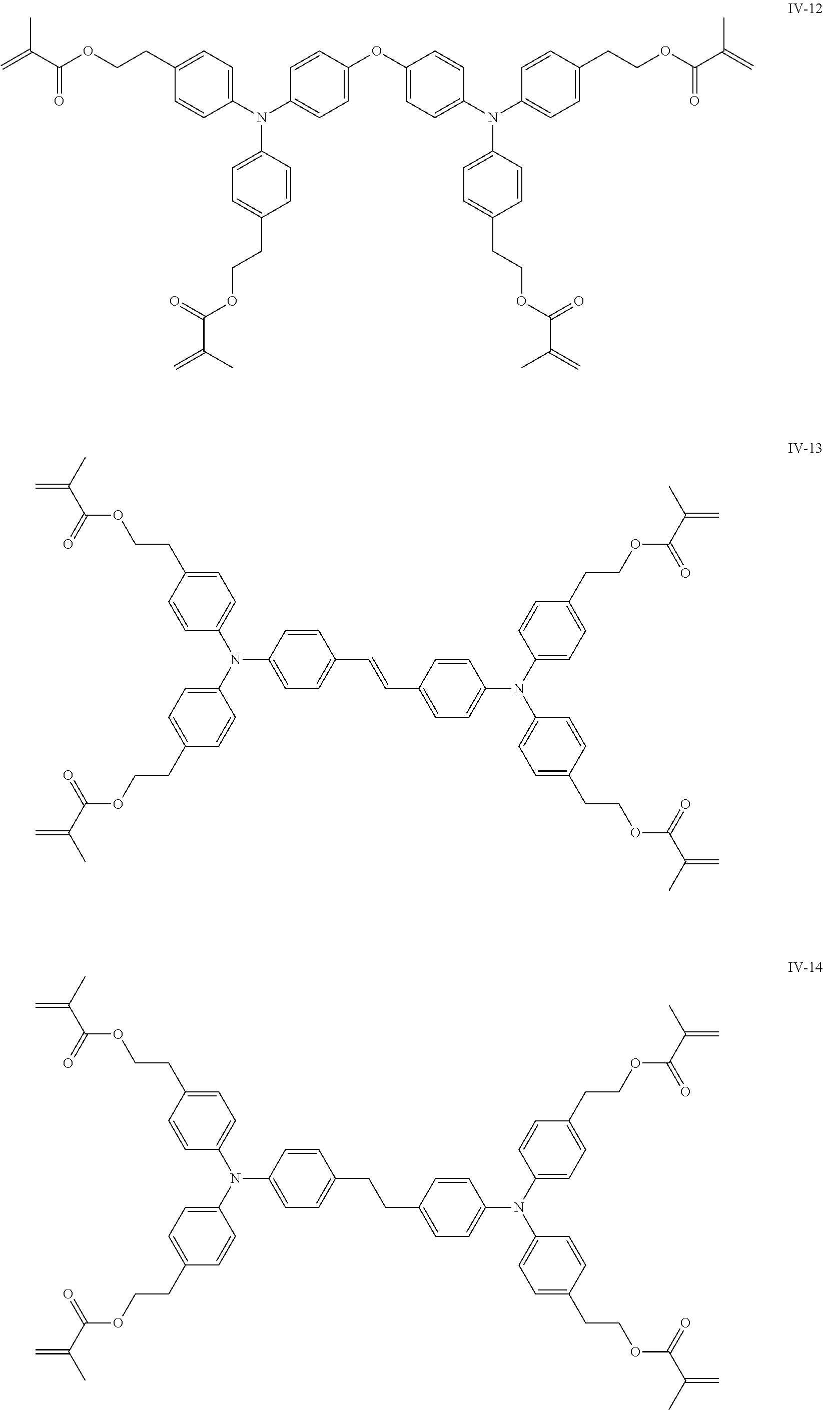

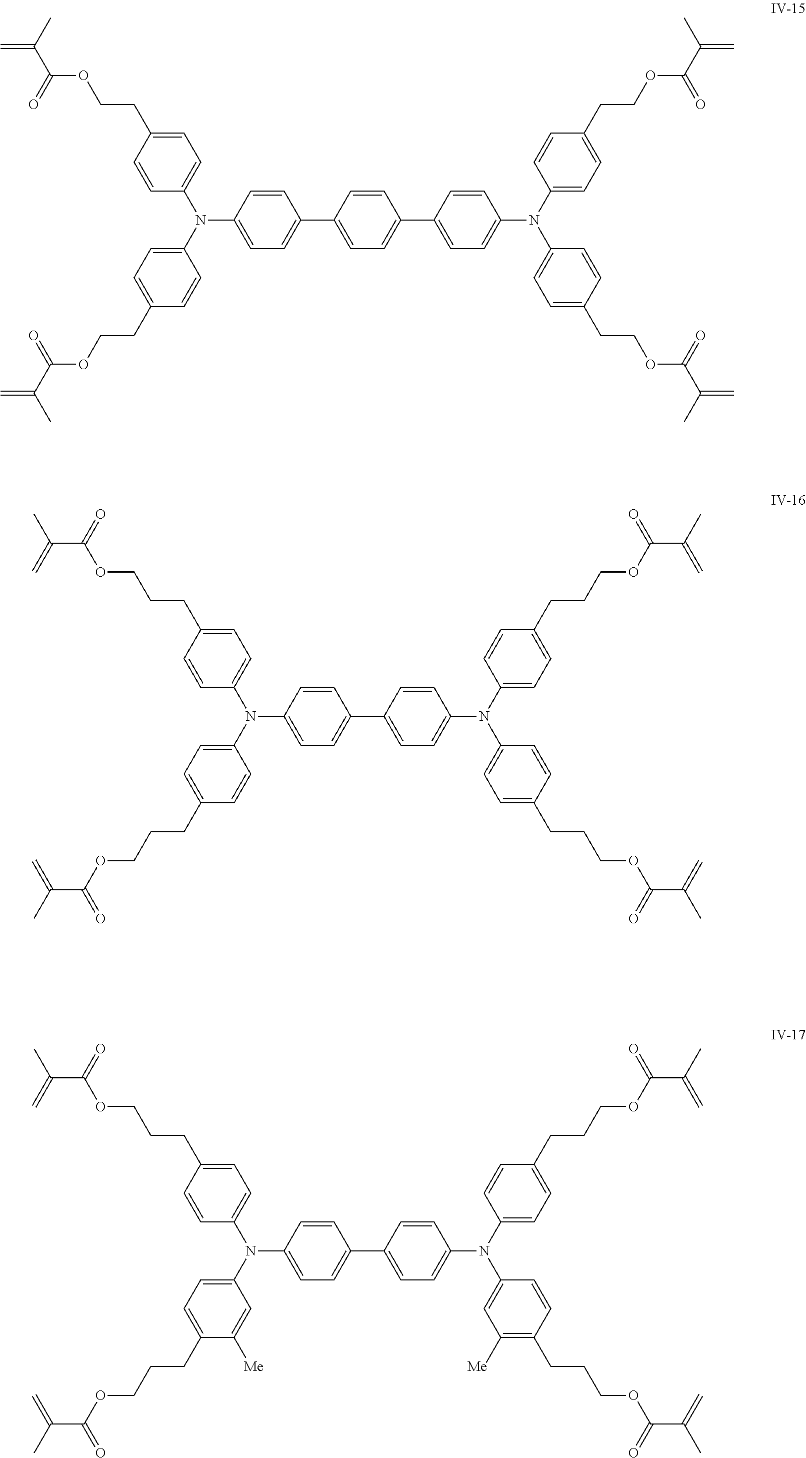

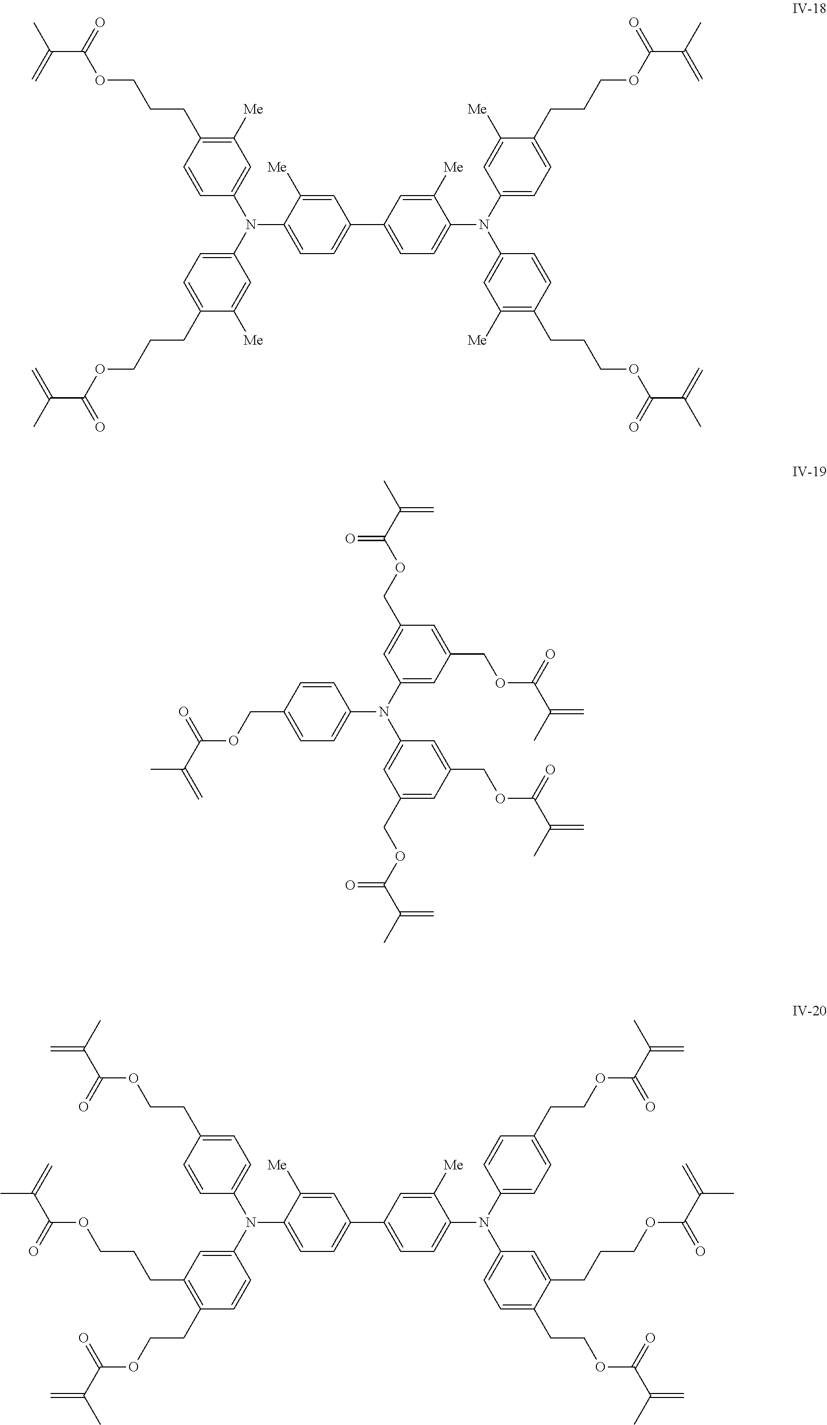

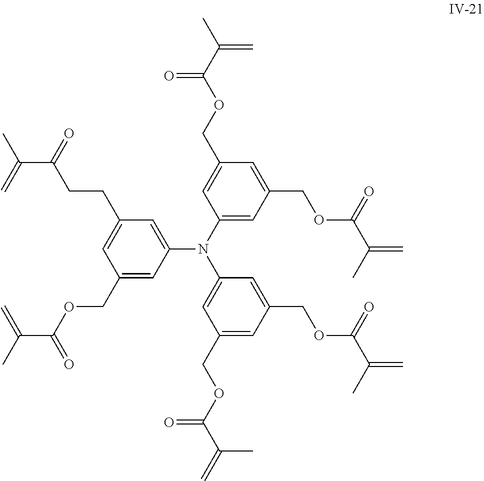

The compounds represented by Formula (A) may be synthesized as follows.

Specifically, a compound represented by Formula (A) is synthesized by condensing an alcohol, which is a precursor, with a compound having a corresponding polymerizable group(s) (e.g., methacrylic acid or halogenated methacrylic acid), or when the alcohol, which is a precursor, has a benzyl alcohol structure, by dehydration etherization with a methacrylic acid derivative having a hydroxy group such as hydroxyethyl methacrylate, or the like.

Examples of the synthesis routes for compounds IV-4 and IV-17 used in exemplary embodiments of the invention are shown below.

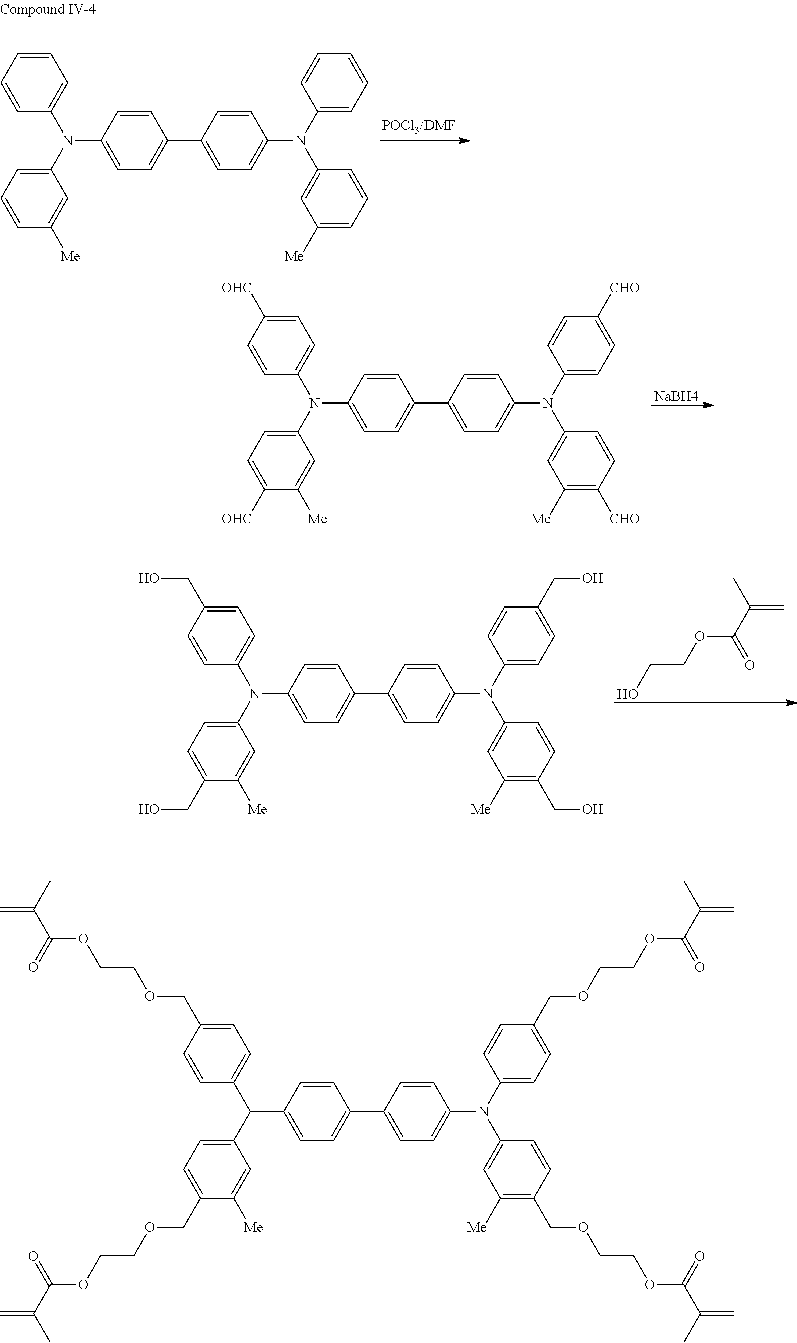

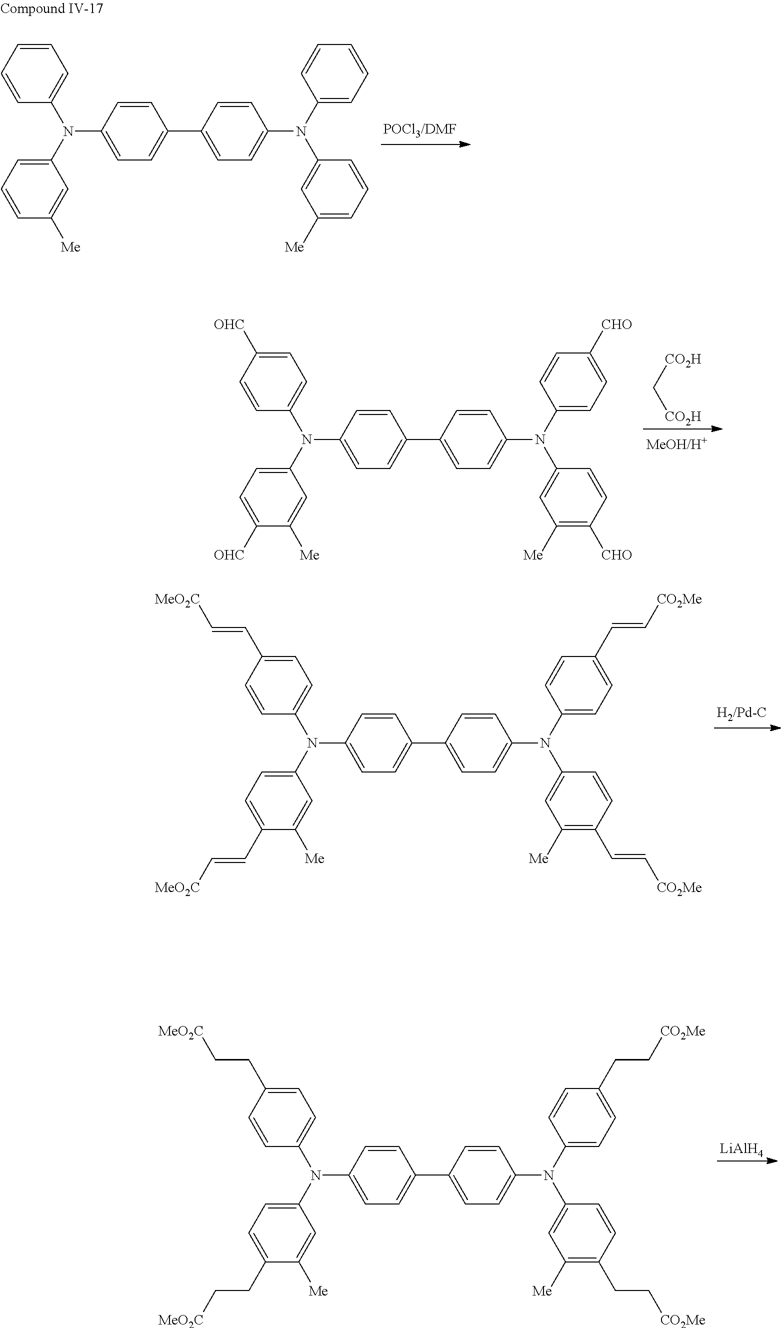

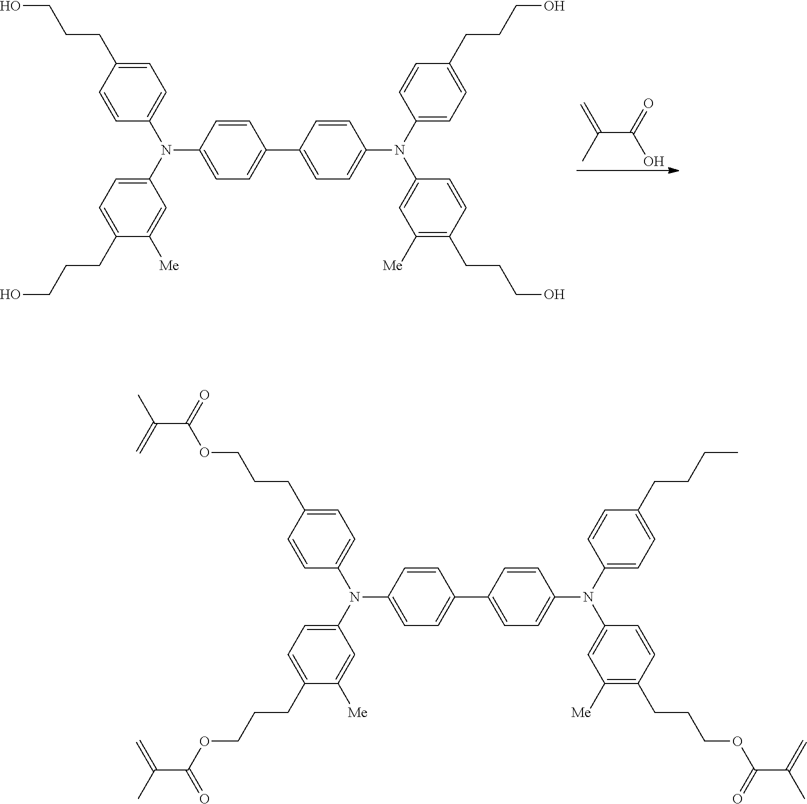

Although the compound having a triphenylamine backbone and two or more polymerizable groups in a molecule thereof is described as above as a preferable example of the charge transporting material, the following compounds (hereinafter referred to as “other polymerizable charge transporting materials”) may be used besides this compound.

Namely, as the other polymerizable charge transporting material, a compound obtained by introducing polymerizable groups into a known charge transporting material may be used. Examples of the known charge transporting material include triarylamine compounds, benzidine compounds, arylalkane compounds, aryl-substituted ethylene compounds, stilbene compounds, anthracene compounds and hydrazone compounds, which are exemplified as positive hole transporting compounds among the charge transporting materials which do not have polymerizable groups mentioned below.

More specifically, as the other polymerizable charge transporting material, a compound having a triphenylamine backbone and one polymerizable group (e.g., an acryloyl group, a methacryloyl group or the like) in the same molecule is preferable. Specific examples thereof include compounds represented by Formula (A) in which the total number of D is changed to 1. Hereinafter specific examples of the other polymerizable charge transporting material are shown.

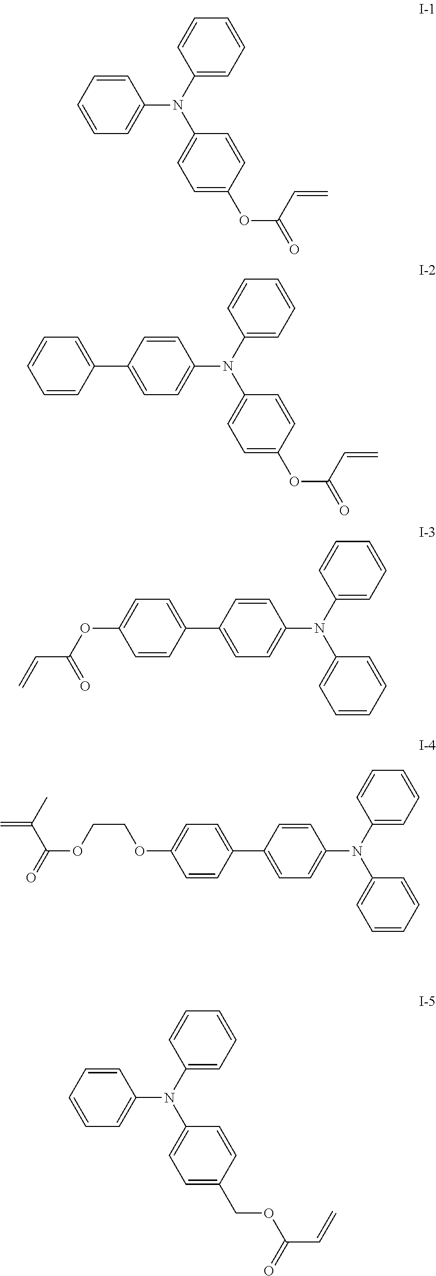

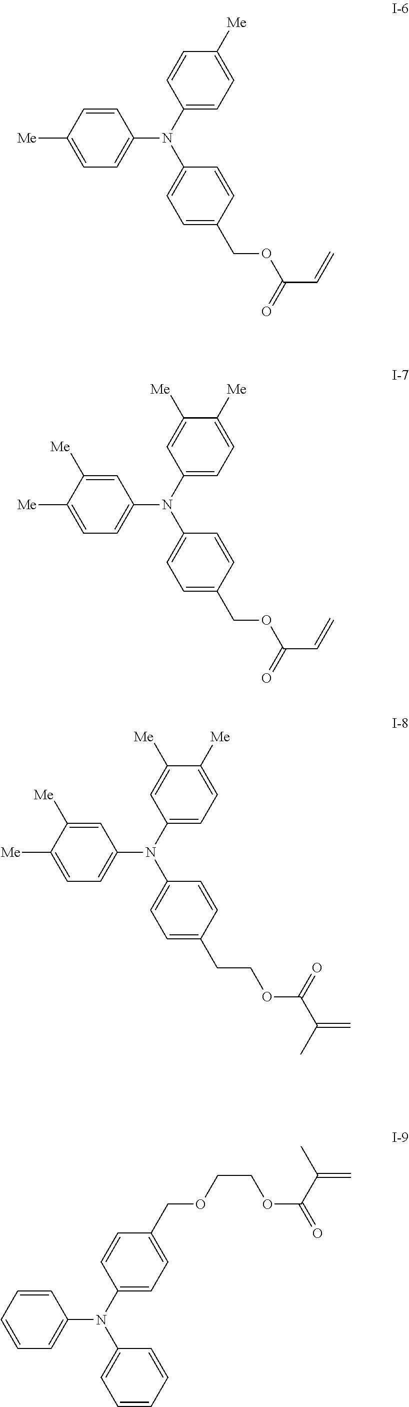

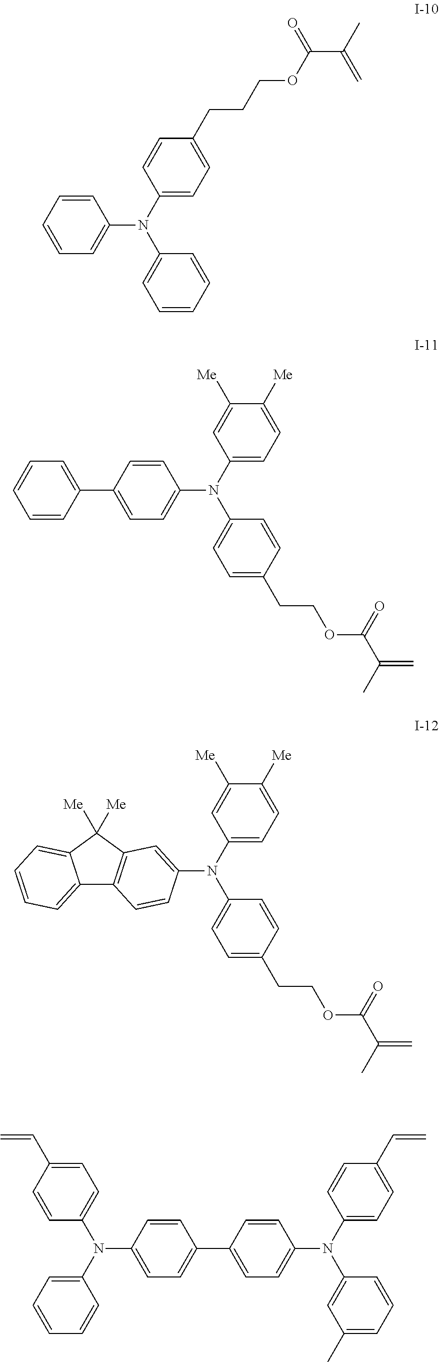

It is preferable that the coating liquid for forming a charge transporting layer 3-1, which is the outermost layer, when the electrophotographic photoreceptor 7A of the exemplary embodiment is produced, contains the charge transporting material in an amount of from 30% by weight to 100% by weight, more preferably from 40% by weight to 100% by weight, and particularly preferably from 50% by weight to 100% by weight, with respect to the total amount of the solid content in the coating liquid.

It is preferable that the charge transporting material has two or more polymerizable groups in a molecule thereof, and it is more preferable to use a compound having a triphenylamine backbone and 4 or more polymerizable groups in a molecule thereof. The amount of the compound having a triphenylamine backbone and 4 or more polymerizable groups in a molecule thereof is preferably 5% by weight or more, more preferably 10% by weight or more, and particularly preferably 15% by weight or more, with respect to the total amount of the solid content in the coating liquid.

Although the charge transporting material having the above-mentioned polymerizable groups is included in the charge transporting layer 3-1, which is the outermost layer, it may be included in the charge transporting layer 3-2 shown in FIG. 1.

As the materials for constituting the charge transporting layer 3-1 which is used as the outermost layer in the exemplary embodiment, a polymerizable material which does not have charge transporting property, a charge transporting material which does not have polymerizable groups, a binding resin and the like may be used, as necessary.

First, the polymerizable material which does not have charge transporting property is described. In an exemplary embodiment, the polymerizable material which does not have charge transporting property refers to, for example, materials which do not have a charge transporting backbone including (meth)acrylate monomers, oligomers and polymers.

Specific examples of the monofunctional monomer include isobutyl acrylate, t-butyl acrylate, isooctyl acrylate, lauryl acrylate, stearyl acrylate, isobornyl acrylate, cyclohexyl acrylate, 2-methoxyethyl acrylate, methoxytriethylene glycol acrylate, 2-ethoxyethyl acrylate, tetrahydrofurfuryl acrylate, benzyl acrylate, ethyl carbitol acrylate, phenoxyethyl acrylate, 2-hydroxy acrylate, 2-hydroxypropyl acrylate, 4-hydroxybutyl acrylate, methoxypolyethylene glycol acrylate, methoxypolyethylene glycol methacrylate, phenoxypolyethylene glycol acrylate, phenoxypolyethylene glycol methacrylate, hydroxyethyl-O-phenylphenol acrylate and O-phenylphenol glycidyl ether acrylate.

Examples of the difunctional monomers, oligomers and polymers include diethylene glycol di(meth)acrylate, polyethylene glycol di(meth)acrylate, polypropylene glycol di(meth)acrylate, neopentyl glycol di(meth)acrylate and 1,6-hexanediol di(meth)acrylate. Examples of the trifunctional monomers, oligomers and polymers include trimethylolpropane tri(meth)acrylate, pentaerythritol tri(meth)acrylate and aliphatic tri(meth)acrylates, and examples of the tetrafunctional monomers, oligomers and polymers include pentaerythritol tetra(meth)acrylate, ditrimethylolpropane tetra(meth)acrylate and aliphatic tetra(meth)acrylates. Examples of penta- or more functional monomers, oligomers and polymers include dipentaerythritol penta(meth)acrylate and dipentaerythritol hexa(meth)acrylate, as well as (meth)acrylates having a polyester backbone, a urethane backbone or a phosphazene backbone. These di- or more functional monomers, oligomers and polymers may be used alone or as a mixture of two or more thereof. These monomers and oligomers may be used in an amount of 100% or less, preferably by 50% or less, and more preferably by 30% or less, with respect to the total amount of the compound having charge transporting property.

Next, the charge transporting material which does not have polymerizable groups is described. Examples of the charge transporting material which does not have polymerizable groups include electron transporting compounds including quinone compounds such as p-benzoquinone, chloranil, bromanil and anthraquinone, tetracyanoquinodimethane compounds, fluorenone compounds such as 2,4,7-trinitrofluorenone, xanthone compounds, benzophenone compounds, cyanovinyl compounds, and ethylene compounds; and known positive hole transporting compounds including triarylamine compounds, benzidine compounds, arylalkane compounds, aryl-substituted ethylene compounds, stilbene compounds, anthracene compounds and hydrazone compounds.

More preferably, the triaryl amine derivative represented by the following structural formula (a-1) and the benzidine derivative represented by the following structural formula (a-2) are preferable in view of charge mobility.

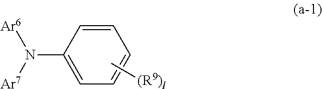

In the formula, R⁹ represents a hydrogen atom or a methyl group; 1 represents 1 or 2; and Ar⁶ and Ar⁷ each independently represent a substituted or unsubstituted aryl group.

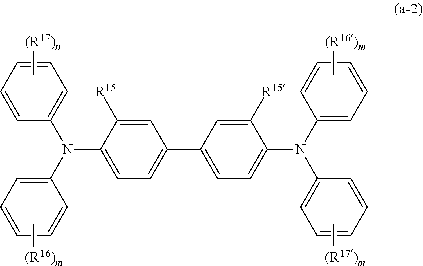

In the formula, R¹⁵ and R^{15′} may be the same as or different from each other, and each independently represent a hydrogen atom, a halogen atom, an alkyl group having 1 to 5 carbon atoms, or an alkoxy group having 1 to 5 carbon atoms; R¹⁶, R^{16′}, R¹⁷ and R^{17′} may be the same as or different from each other, and each independently represent a hydrogen atom, a halogen atom, an alkyl group having 1 to 5 carbon atoms, an alkoxy group having 1 to 5 carbon atoms, an amino group substituted by an alkyl group having 1 or 2 carbon atoms, or a substituted or unsubstituted aryl group; and m and n each independently represent an integer of 0 to 2.

Furthermore, a polymer charge transporting compound which does not have polymerizable groups, such as poly-N-vinylcarbazole and polysilane may be used. Specifically, among known non-crosslinkable type polymer charge transporting materials, the polyester polymer charge transporting materials as those disclosed in JP-A Nos. 8-176293, 8-208820 and the like are particularly preferable. The polymer charge transporting material itself may be formed into a film, or may be mixed with the binding resin mentioned below and formed into a film. These charge transporting materials may be used alone or as a mixture of two or more thereof, and are not limited to these materials.

Specific examples of the binding resin which may be used for the charge transporting layer include polycarbonate resins, polyester resins, polyarylate resins, methacrylic resins, acrylic resins, polyvinyl chloride resins, polyvinylidene chloride resins, polystyrene resins, polyvinyl acetate resins, styrene-butadiene copolymers, vinylidene chloride-acrylonitrile copolymers, vinyl chloride-vinyl acetate copolymers, vinyl chloride-vinyl acetate-maleic anhydride copolymers, silicone resins, silicone alkyd resins, phenol-formaldehyde resins, styrene-alkyd resins, poly N-vinylcarbazole and polysilane. Furthermore, as mentioned above, polymer charge transporting materials such as the polyester polymer charge transporting materials as those disclosed in JP-A Nos. 8-176293 and 8-208820 may also be used. Among these, polycarbonate resins and polyarylate resins are preferable.

These binding resins are used alone, or as a mixture of two or more thereof. The incorporation ratio of the charge transporting material to the binding resin (charge transporting material/binding resin) is preferably from 10/1 to 1/5 by weight ratio.

The charge transporting layer in the exemplary embodiment includes at least an organic solvent having a boiling point of from 65° C. to 250° C. Specifically, a photoreceptor may be produced using a coating solution in which the above-mentioned charge transfer material is dissolved in an organic solvent having a boiling point of from 65° C. to 250° C., or in such a manner that a photoreceptor is produced, and then immersed in an organic solvent having a boiling point of from 65° C. to 250° C.

Examples of the organic solvent having a boiling point of from 65° C. to 250° C. include alcohols such as n-heptanol, 3-heptanol, 2-octanol, 2-ethylhexanol, 3,5,5-trimethylhexanol, n-decanol, cyclohexanol, 2-methyl-cyclohexanol, benzyl alcohol, furfuryl alcohol and tetrahydrofurfuryl alcohol; ethers such as diisoamyl ether, n-hexyl ether, ethyleneglycol dibutyl ether, diethyleneglycol monoethyl ether, diethyleneglycol monobutyl ether and diethyleneglycol diethyl ether; ketones such as methyl n-hexyl ether, diisobutyl ketone and methylcyclohexanone; and esters such as methoxybutyl acetate, 2-ethylbutyl acetate, cyclohexyl acetate, butyl acetate and dibutyl oxalate.

Among these organic solvents, methyl n-hexyl ether, diisobutyl ketone, methylcyclohexanone, diethylene glycol diethyl ether, butyl acetate, dibutyl oxalate and cyclohexyl acetate are preferable.

In the exemplary embodiment, the amount of the organic solvent included in charge transporting layer 3-1, which is the outermost layer, is from 5,000 ppm to 50,000 ppm.

During formation of a charge transporting layer using a coating solution for forming a charge transporting layer, as the organic solvent having a boiling point of from 65° C. to 250° C., any of general organic solvents including aromatic hydrocarbons such as benzene, toluene, xylene and chlorobenzene, ketones such as acetone and 2-butanone, halogenated aliphatic hydrocarbons such as methylene chloride, chloroform and ethylene chloride, and cyclic or linear ethers such as tetrahydrofuran and ethyl ether may be used in combination.

As a coating method for applying the coating solution for forming a charge transporting layer, a method such as a blade coating method, a Meyer bar coating method, a spray coating method, a dip coating method, a bead coating method, an air knife coating method, a curtain coating method or an inkjet method is used.

The film thickness of the charge transporting layer is preferably from 10 μm to 60 μm, and more preferably 20 μm to 60 μm.

The charge transporting layer 3-1, which is the outermost layer in the exemplary embodiment, may be formed by polymerization by heat energy. During the polymerization, a polymerization catalyst is not necessarily required, but it is particularly preferable to add a catalyst.

Examples of the heat polymerization initiator (polymerization catalyst) include V-30, V-40, V-59, V-601, V-65, V-70, VF-096, VAM-110 and VAM-111 (trade names, manufactured by Wako Pure Chemical Industries Ltd.), and azo polymerization initiators including OTAZO-15, OTAZO-30, AIBN, AMBN, ADVN and ACVA (trade names, manufactured by Otsuka Chemical Co., Ltd.), as well as PERTETRA A, PERHEXA HC, PERHEXA C, PERHEXA V, PERHEXA 22, PERHEXA MC, PERBUTYL H, PERCUMYL H, PERCUMYL P, PERMENTA H, PEROCTA H, PERBUTYL C, PERBUTYL D, PERHEXYL D, PEROYL IB, PEROYL 355, PEROYL L, PEROYL SA, NYPER BW, NYPER BMT-K40/M, PEROYL IPP, PEROYL NPP, PEROYL TCP, PEROYL OPP, PEROYL SBP, PERCUMYL ND, PEROCTA ND, PERHEXYL ND, PERBUTYL ND, PERBUTYL NHP, PERHEXYL PV, PERBUTYL PV, PERHEXA 250, PEROCTA O, PERHEXYL O, PERBUTYL O, PERBUTYL L, PERBUTYL 355, PERHEXYL I, PERBUTYL I, PERBUTYL E, PERHEXA 25Z, PERBUTYL A, PERHEXYL Z, PERBUTYL ZT and PERBUTYL Z (trade names, manufactured by NOF Corporation), KAYAKETAL AM-055, TRIGONOX 36-C75, LAUROX, PERCADOX L-W75, PERCADOX CH-50L, TRIGONOX TMBH, KAYACUMENE H, KAYABUTYL H-70, PERCADOX BC-FF, KAYAHEXA AD, PERCADOX 14, KAYABUTYL C, KAYABUTYL D, KAYAHEXA YD-E85, PERCADOX 12-XL25, PERCADOX 12-EB20, TRIGONOX 22-N70, TRIGONOX 22-70E, TRIGONOX D-T50, TRIGONOX 423-C70, KAYAESTER CND-C70, KAYAESTER CND-W50, TRIGONOX 23-C70, TRIGONOX 23-W50N, TRIGONOX 257-C70, KAYAESTER P-70, KAYAESTER TMPO-70, TRIGONOX 121, KAYAESTER O, KAYAESTER HTP-65W, KAYAESTER AN, TRIGONOX 42, TRIGONOX F-050, KAYABUTYL B, KAYACARBON EH-C70, KAYACARBON EH-W60, KAYACARBON I-20, KAYACARBON BIC-75, TRIGONOX 117 and KAYALENE 6-70 (trade names, manufactured by Kayaku Akzo Co., Ltd.), and LUPEROX 610, LUPEROX 188, LUPEROX 844, LUPEROX 259, LUPEROX 10, LUPEROX 701, LUPEROX 11, LUPEROX 26, LUPEROX 80, LUPEROX 7, LUPEROX 270, LUPEROX P, LUPEROX 546, LUPEROX 554, LUPEROX 575, LUPEROX TANPO, LUPEROX 555, LUPEROX 570, LUPEROX TAP, LUPEROX TBIC, LUPEROX TBEC, LUPEROX JW, LUPEROX TAIC, LUPEROX TAEC, LUPEROX DC, LUPEROX 101, LUPEROX F, LUPEROX DI, LUPEROX 130, LUPEROX 220, LUPEROX 230, LUPEROX 233 and LUPEROX 531.

These catalysts are added in an amount of from 0.2% to 10% by weight, preferably from 0.5% to 8% by weight, and more preferably from 0.7% to 5% by weight, with respect to the total amount of the solid content when a coating solution containing a compound having a charge transporting backbone and polymerizable groups such as an acryl group or a methacryl group is prepared.

It is preferable that the polymerization reaction is carried out in vacuo, or at a low oxygen concentration of an oxygen concentration of 10% or less, preferably 5% or less, more preferably 2% or less such as under inert gas atmosphere, so that the chain reaction may be carried out without deactivating radicals generated by heat energy.

In an exemplary embodiment of the invention, a polymer which can react or does not react with the compound having a charge transporting backbone and polymerizable groups such as an acrylic group or a methacryl group may be mixed with the compound in the charge transporting layer.

Examples of the polymer which may be reacted include those disclosed in JP-A Nos. 5-216249, 5-323630, 11-52603, 2000-264961 and the like. Examples of the polymer which does not react include known polymers including polycarbonate resins, polyester resins, polyarylate resins, methacrylic resins, acrylic resins, polyvinyl chloride resins, polyvinylidene chloride resins and polystyrene resins. These polymers may be used in an amount of 100% by weight or less, preferably 50% by weight or less, and more preferably 30% by weight or less, with respect to the total amount of the compound having charge transporting property.

In an exemplary embodiment of the invention, the charge transporting layer may further include an additional coupling agent or fluorine compound. As such compound, various silane coupling agents and commercially available silicone hard coating agents may be used.

Examples of the silane coupling agent include vinyltrichlorosilane, vinyltrimethoxysilane, vinyltriethoxysilane, γ-glycidoxypropylmethyldiethoxysilane, γ-glycidoxypropyltrimethoxysilane, γ-glycidoxypropyltriethoxysilane, γ-aminopropyltriethoxysilane, γ-aminopropyltrimethoxysilane, γ-aminopropylmethyldimethoxysilane, N-β(aminoethyl)-γ-aminopropyltriethoxysilane, tetramethoxysilane, methyltrimethoxysilane and dimethyldimethoxysilane. Examples of the commercially available hard coating agent include KP-85, X-40-9740 and X-8239 (trade names, manufactured by Shin-Etsu Chemical Co., Ltd.), and AY42-440, AY42-441 and AY49-208 (trade names, manufactured by Dow Corning Toray Co., Ltd.). Furthermore, in order to provide water repellency and the like, a fluorine-containing compound such as (tridecafluoro-1,1,2,2-tetrahydrooctyl)triethoxysilane, (3,3,3-trifluoropropyl)trimethoxysilane, 3-(heptafluoroisopropoxy)propyltriethoxysilane, 1H,1H,2H,2H-perfluoroalkyltriethoxysilane, 1H,1H,2H,2H-perfluorodecyltriethoxysilane or 1H,1H,2H,2H-perfluorooctyltriethoxysilane may be added. The amount of the silane coupling agent is arbitrary; however, the amount of the fluorine-containing compound is preferably 0.25 fold or less by weight with respect to the compound free from fluorine. When the amount of the fluorine-containing compound exceeds the above-mentioned amount, a problem may occur in the film forming property of the crosslinked film. Furthermore, a polymerizable fluorine compound as those disclosed in JP-A No. 2001-166510 and the like may be mixed.

Moreover, a resin which dissolves in alcohols may be added.

When the coating liquid is obtained by reacting the above-mentioned components, the components may simply be mixed and dissolved, or may be heated to from room temperature (20° C.) to 100° C., and more preferably from 30° C. to 80° C., for from 10 minutes to 100 hours, and preferably from 1 hour to 50 hours. At this time, it is preferable to irradiate radiation ray.

A deterioration inhibitor may be added to the charge transporting layer. Preferable examples of the deterioration inhibitor include hindered phenols and hindered amines. Alternatively, any of known antioxidants such as organic sulfur antioxidants, phosphite antioxidants, dithiocarbamate antioxidants, thiourea antioxidants and benzoimidazole antioxidants may be used. The amount of the deterioration inhibitor to be used is preferably 20% by weight or less, more preferably 10% by weight or less, with respect to the total amount of the solid content in the charge transporting layer.

Examples of the hindered phenol antioxidants include “IRGANOX 1076”, “IRGANOX 1010”, “IRGANOX 1098”, “IRGANOX 245”, “IRGANOX 1330”, “IRGANOX 3114” and “IRGANOX 1076” (trade names, manufactured by Ciba Japan), and “3,5-di-t-butyl-4-hydroxybiphenyl”.

Examples of the hindered amine antioxidants include “SANOL LS2626”, “SANOL LS765”, “SANOL LS770” and “SANOL LS744” (trade names, manufactured by Sankyo Lifetech Co., Ltd.), “TINUVIN 144”, “TINUVIN 622LD” (trade names, manufactured by Ciba Japan), and “MARK LA57”, “MARK LA67”, “MARK LA62”, “MARK LA68” and “MARK LA63” (trade names, manufactured by Adeka Corporation); examples of the thioether antioxidants include “SUMILIZER TPS” and “SUMILIZER TP-D” (trade names, manufactured by Sumitomo Chemical Co., Ltd.); and examples of the phosphate antioxidants include “MARK 2112”, “MARK PEP-8”, “MARK PEP-24G”, “MARK PEP-36”, “MARK 329K” and “MARK HP-10” (trade names, manufactured by Adeka Corporation).

Furthermore, any of electroconductive particles, organic particles, inorganic particles, and the like may be added to the charge transporting layer so as to decrease residual potential or increase strength. Examples of the particles include silicon-containing particles. The silicon-containing particles refer to particles which include silicon as a constitutional element, and specific examples thereof include colloidal silica and silicone particles. The colloidal silica used as the silicon-containing particles is selected from silica having an average particle size of from 1 nm to 100 nm, and preferably from 10 nm to 30 nm, and is used after being dispersed in an acidic or alkaline aqueous dispersion liquid or in an organic solvent such as an alcohol, a ketone or an ester. Commercially-available silica may be used. Although the solid content of the colloidal silica is not particularly limited, it is used by an amount in the range of from 0.1% by weight to 50% by weight, preferably from 0.1% by weight to 30% by weight with respect to the total solid content.

The silicone particles used as the silicon-containing particles are selected from silicone resin particles, silicone rubber particles, and treated silica particles whose surfaces have been treated with silicone, and commercially available silicone particles may be used. These silicone particles are spherical, and the average particle size is preferably from 1 nm to 500 nm, and more preferably from 10 nm to 100 nm. The amount of the silicone particles is preferably from 0.1% by weight to 30% by weight, more preferably from 0.5% by weight to 10% by weight, with respect to the total solid content in the charge transport layer,

Examples of other particles include fluorine-containing particles such as ethylene tetrafluoride, ethylene trifluoride, propylene hexafluoride, vinyl fluoride and vinylidene fluoride; particles consisting of a resin obtained by copolymerizing a fluorine resin with monomers having a hydroxy group as shown in “Collected Abstract of 8^{th} Polymer Material Forum, pp 89-90”; and semiconductive metal oxides such as ZnO—Al₂O₃, SnO₂—Sb₂O₃, In₂O₃—SnO₂, ZnO₂—TiO₂, ZnO—TiO₂, MgO—Al₂O₃, FeO—TiO₂, TiO₂, SnO₂, In₂O₃, ZnO and MgO. Furthermore, an oil such as a silicone oil may be added. Examples of the silicone oil include silicone oils such as dimethylpolysiloxane, diphenylpolysiloxane and phenylmethylsiloxane; polymerizable silicone oils such as amino-modified polysiloxane, epoxy-modified polysiloxane, carboxyl-modified polysiloxane, carbinol-modified polysiloxane, methacryl-modified polysiloxane, mercapto-modified polysiloxane and phenol-modified polysiloxane; cyclic dimethylcyclosiloxanes such as hexamethylcyclotrisiloxane, octamethylcyclotetrasiloxane, decamethylcyclopentasiloxane and dodecamethylcyclohexasiloxane; cyclic methylphenylcyclosiloxanes such as 1,3,5-trimethyl-1,3,5-triphenylcyclotrisiloxane, 1,3,5,7-tetramethyl-1,3,5,7-tetraphenylcyclotetrasiloxane and 1,3,5,7,9-pentamethyl-1,3,5,7,9-pentaphenylcyclopentasiloxane; cyclic phenylcyclosiloxanes such as hexaphenylcyclotrisiloxane; fluorine-containing cyclosiloxanes such as 3-(3,3,3-trifluoropropyl)methylcyclotrisiloxane; hydrosilyl group-containing cyclosiloxanes such as methylhydrosiloxane mixtures, pentamethylcyclopentasiloxane and phenylhydrocyclosiloxane; and vinyl group-containing cyclosiloxanes such as pentavinylpentamethylcyclopentasiloxane.

Furthermore, any of a metal, a metal oxide, carbon black and the like may be added. Examples of the metal include aluminum, zinc, copper, chromium, nickel, silver and stainless, and plastic particles on which any of these metals have been deposited. Examples of the metal oxide include zinc oxide, titanium oxide, tin oxide, antimony oxide, indium oxide, bismuth oxide, indium oxide on which tin has been doped, tin oxide on which antimony or tantalum has been doped, and zirconium oxide on which antimony has been doped. These may be used alone or as a combination of two or more thereof. When two or more kinds are used in combination, they may be simply mixed, or formed into a solid solution or a fused product. The average particle size of the electroconductive particles is 0.3 μm or less, and preferably 0.1 μm or less, in view of transparency.

Charge Transporting Layer 3-2

Charge transporting layer 3-2 shown in FIG. 1 may be formed using the materials used for the above-mentioned charge transporting layer 3-1.

The binding resin used for the charge transporting layer 3-2 has a weight average molecular weight of preferably 50,000 or more, and more preferably 55,000 or more, in view of the relationship to the compound having a triphenylamine backbone and two or more polymerizable groups in a molecule thereof contained in charge transporting layer 3-1.

Electroconductive Substrate

Examples of electroconductive substrate 4 include metal plates, metal drums and metal belts which may be formed using a metal such as aluminum, copper, zinc, stainless, chromium, nickel, molybdenum, vanadium, indium, gold or platinum or an alloy thereof, and paper sheets, plastic films and belts obtained by coating, depositing or laminating an electroconductive compound such as a conductive polymer, indium oxide, or a metal such as aluminum, palladium or gold or an alloy thereof.

When electrophotographic photoreceptor 7A is used in a laser printer, it is preferable that the surface of electroconductive substrate 4 is roughened so as to have a center line average roughness Ra of from 0.04 μm to 0.5 μm so as to prevent interference fringes which are formed when irradiated by laser light.

Preferable examples of the method for surface roughening include wet honing in which an abrasive suspended in water is blown onto a support, centerless grinding in which a support is continuously ground by pressing the support onto a rotating grind stone, and anodic oxidation.

As another method of surface roughening, a method which does not include surface roughening of electroconductive substrate 4 is preferably used, in which a layer containing conductive or semiconductive particles dispersed in a resin is formed on a surface of the support so that the surface is made roughened by the particles dispersed in the layer.

In the surface-roughening treatment by anodic oxidation, an oxide film is formed on an aluminum surface by anodic oxidation in which the aluminum as anode is anodized in an electrolyte solution. Examples of the electrolyte solution include a sulfuric acid solution and an oxalic acid solution. However, the porous anodic oxide film formed by anodic oxidation without modification is chemically active. Therefore, it is preferable to conduct a sealing treatment in which fine pores of the anodic oxide film are sealed by cubical expansion caused by a hydration reaction in pressurized water vapor or boiled water (to which a metallic salt such as a nickel salt may be added) to transform the anodic oxide into a more stable hydrated oxide.

The thickness of the anodic oxide film is preferably from 0.3 μm to 15 μm.

Electroconductive substrate 4 may be subjected to a treatment with an acidic aqueous solution or a boehmite treatment. The treatment with an acidic treatment liquid including phosphoric acid, chromic acid and hydrofluoric acid is carried out as follows. First, phosphoric acid, chromic acid and hydrofluoric acid are mixed to prepare an acidic treatment liquid preferably in a mixing ratio of in the range of from 10% by weight to 11% by weight of phosphoric acid, in the range of from 3% by weight to 5% by weight of chromic acid, and in the range of from 0.5% by weight to 2% by weight of hydrofluoric acid. The concentration of the total acid components is preferably in the range of from 13.5% by weight to 18% by weight. The treatment temperature is preferably from 42° C. to 48° C. The thickness of the film is preferably from 0.3 μm to 15 μm.

The boehmite treatment is carried out by immersing the substrate in pure water at a temperature of from 90° C. to 100° C. for from 5 minutes to 60 minutes, or by bringing it into contact with heated water vapor at a temperature of from 90° C. to 120° C. for from 5 minutes to 60 minutes. The film thickness of the film is preferably from 0.1 μm to 5 μm. The film may further be subjected to anodic oxidation using an electrolyte solution which scarcely dissolves the film and includes any of adipic acid, boric acid, borate, phosphate, phthalate, maleate, benzoate, tartrate, citrate and the like.

Undercoating Layer

Undercoating layer 1 may be formed from only a binding resin or a binding resin containing inorganic particles.

The inorganic particles preferably have a powder resistance (volume resistivity) of from 10²·Ωcm to 10¹¹·Ωcm so that undercoating layer 1 obtains adequate resistance in order to achieve leak resistance and carrier blocking properties.

Examples of the inorganic particles having the above-mentioned resistance value include inorganic particles of tin oxide, titanium oxide, zinc oxide, zirconium oxide and the like, and zinc oxide is particularly preferable. The inorganic particles may be the ones which are subjected to a surface treatment. Particles which are subjected to different surface treatments, or those having different particle diameters, may be used in combination of two or more kinds.

Inorganic particles having a specific surface area measured by BET method of 10 m²/g or more are preferably used. When the specific surface area is less than 10 m²/g, lowering of electrostatic properties may easily be caused, and favorable electrophotographic characteristics may not be obtained.

By containing inorganic particles and acceptor compounds, an undercoating layer which is superior in long-term stability of electrical characteristics and carrier blocking property may be obtained. Any acceptor compound with which desired characteristics is obtained may be used, but examples thereof include electron transporting substances including quinone-based compounds such as chloranil and bromanil, tetracyanoquinodimethane compounds, fluorenone compounds such as 2,4,7-trinitrofluorenone and 2,4,5,7-tetranitro-9-fluorenone, oxadiazole compounds such as 2-(4-biphenyl)-5-(4-t-butylphenyl)-1,3,4-oxadiazole, 2,5-bis(4-naphthyl)-1,3,4-oxadiazole and 2,5-bis(4-diethylaminophenyl)-1,3,4-oxadiazole, xanthone compounds, thiophene compounds and diphenoquinone compounds such as 3,3′,5,5′-tetra-t-butyldiphenoquinone, and compounds having an anthraquinone structure are particularly preferable. Still more preferable examples include acceptor compounds having an anthraquinone structure, such as hydroxyanthraquinone compounds, aminoanthraquinone compounds and aminohydroxyanthraquinone compounds, and specific examples thereof include anthraquinone, alizarin, quinizarin, anthrarufin and purpurin.

The amount of the acceptor compound may be determined as appropriate as long as desired characteristics are obtained, but preferably in the range of from 0.01% by weight to 20% by weight with respect to the inorganic particles, and more preferably in the range of from 0.05% by weight to 10% by weight with respect to the inorganic particles in view of preventing accumulation of charge and aggregation of inorganic particles. The aggregation of the inorganic particles may cause irregular formation of conductive channels, deterioration of maintainability such as increase in residual potential, or image defects such as black points, when repeatedly used.

The acceptor compound may simply be added at the time of application of the undercoating layer, or may be previously attached to the surface of the inorganic particles. Examples of the method of attaching the acceptor compound to the surface of the inorganic particles include a dry method and a wet method.

When a surface treatment is conducted according to the dry method, the acceptor compound is added dropwise to the inorganic particles or sprayed thereto together with dry air or nitrogen gas, either directly or in the form of a solution in which the acceptor compound is dissolved in an organic solvent, while the inorganic particles are stirred with a mixer or the like having a high shearing force, whereby the particles are treated evenly without causing irregular formation. The addition or spraying is preferably carried out at a temperature of the boiling point of the solvent or less. If the spraying is carried out at a temperature of not less than the boiling point of the solvent, there is a disadvantage in that the solvent evaporates before the inorganic particles are stirred uniformly and the acceptor compound coagulates locally so that the uniform treatment will be difficult to conduct, which is undesirable. After the addition or spraying of the acceptor compound, the inorganic particles may further be baked at a temperature of 100° C. or more. The baking may be carried out at any temperature and timing by which desired electrophotographic characteristics is obtained.

In the wet method, the inorganic particles are dispersed in a solvent by means of stirring, ultrasonic wave, a sand mill, an attritor, a ball mill or the like, then the acceptor compound is added and the mixture is further stirred or dispersed, followed by removal of the solvent, whereby the particles are uniformly treated. The solvent is removed by filtration or distillation. After removal of the solvent, the particles may be baked at a temperature of 100° C. or more. The baking may be carried out at any temperature and timing as long as desired electrophotographic characteristics are obtained. In the wet method, the moisture contained in the inorganic particles may be removed prior to the addition of the surface treatment agent. The moisture may be removed by, for example, stirring and heating the particles in the solvent used for the surface treatment, or by azeotropic removal with the solvent.

The inorganic particles may be subjected to a surface treatment prior to the addition of the acceptor compound. The surface treatment agent may be any agent as long as desired characteristics are obtained, and may be selected from known materials. Examples thereof include silane coupling agents, titanate coupling agents, aluminum coupling agents and surfactants. Among these, silane coupling agents are preferably used because favorable electrophotographic characteristics may be provided, and examples thereof include the silane coupling agents having an amino group because favorable blocking properties may be imparted to undercoating layer 1.

The silane coupling agents having amino groups may be any compounds as long as desired electrophotographic photoreceptor characteristics are obtained. Specific examples thereof include, but are not limited to, γ-aminopropyltriethoxysilane, N-β-(aminoethyl)-γ-aminopropyltrimethoxysilane, N-β-(aminoethyl)-γ-aminopropylmethylmethoxysilane and N,N-bis(β-hydroxyethyl)-γ-aminopropyltriethoxysilane.

The silane coupling agents may be used as a combination of two or more thereof. Examples of the silane coupling agent which may be used in combination with the silane coupling agents having an amino group include, but are not limited to, vinyltrimethoxysilane, γ-methacryloxypropyl-tris-(β-methoxyethoxy)silane, β(3,4-epoxycyclohexyl)ethyltrimethoxysilane, γ-glycidoxypropyltrimethoxysilane, vinyltriacetoxysilane, γ-mercaptopropyltrimethoxysilane, γ-aminopropyltriethoxysilane, N-β-(aminoethyl)-γ-aminopropyltrimethoxysilane, N-β-(aminoethyl)-γ-aminopropylmethylmethoxysilane, N,N-bis(β-hydroxyethyl)-γ-aminopropyltriethoxysilane and γ-chloropropyltrimethoxysilane.

The surface treatment method may be any known method, and dry or wet method may be used. Addition of an acceptor and a surface treatment using a coupling agent or the like may be carried out simultaneously.

The amount of the silane coupling agent relative to the inorganic particles contained in undercoating layer 1 may be determined as appropriate as long as it is an amount at which the desired electrophotographic characteristics is obtained, but preferably from 0.5% by weight to 10% by weight relative to the inorganic particles in view of improving dispersibility.

As the binding resin contained in undercoating layer 1, any known resin that may form a favorable film and achieve desired characteristics may be used. Examples thereof include known polymer resin compounds, e.g. acetal resins such as polyvinyl butyral resins, polyvinyl alcohol resins, casein, polyamide resins, cellulose resins, gelatin, polyurethane resins, polyester resins, methacrylic resins, acrylic resins, polyvinyl chloride resins, polyvinyl acetate resins, vinyl chloride-vinyl acetate-maleic anhydride resins, silicone resins, silicone-alkyd resins, phenolic resins, phenol-formaldehyde resins, melamine resins and urethane resins; zirconium chelate compounds; titanium chelate compounds; aluminum chelate compounds; titanium alkoxide compounds; organic titanium compounds; silane coupling compounds; charge transporting resins having charge transporting groups; and conductive resins such as polyaniline resins. In particular, resins which are insoluble in the coating solvent for the upper layer are preferably used, and specific examples thereof include phenolic resins, phenol-formaldehyde resins, melamine resins, urethane resins, and epoxy resins. When these resins are used in combination of two or more kinds, the mixing ratio may be suitably determined as necessary.

The ratio of the metal oxide to which acceptor property is imparted to the binder resin, or the ratio of the inorganic particles to the binder resin, in the coating solution for forming an undercoating layer, may be appropriately determined within a range in which the desired electrophotographic photoreceptor characteristics are obtained.

Various additives may be used for undercoating layer 1 to improve electrical characteristics, environmental stability or image quality. Examples of the additives include known materials including polycondensed electron transporting pigments and azo electron transporting pigments, zirconium chelate compounds, titanium chelate compounds, aluminum chelate compounds, titanium alkoxide compounds, organic titanium compounds and silane coupling agents. Silane coupling agents, which are used for surface treatment of metal oxides, may also be added to the coating solution as additives. Specific examples of the silane coupling agents include vinyltrimethoxysilane, γ-methacryloxypropyl-tris(β-methoxyethoxy)silane, β(3,4-epoxycyclohexyl)ethyltrimethoxysilane, γ-glycidoxypropyltrimethoxysilane, vinyltriacetoxysilane, γ-mercaptopropyltrimethoxysilane, γ-aminopropyltriethoxysilane, N-β-(aminoethyl)-γ-aminopropyltrimethoxysilane, N-β-(aminoethyl)-γ-aminopropylmethylmethoxysilane, N,N-bis(β-hydroxyethyl)-γ-aminopropyltriethoxysilane and γ-chloropropyltrimethoxysilane. Examples of the zirconium chelate compounds include zirconium butoxide, zirconium ethyl acetoacetate, zirconium triethanolamine, acetylacetonate zirconium butoxide, ethyl acetoacetate zirconium butoxide, zirconium acetate, zirconium oxalate, zirconium lactate, zirconium phosphonate, zirconium octanoate, zirconium naphthenate, zirconium laurate, zirconium stearate, zirconium isostearate, methacrylate zirconium butoxide, stearate zirconium butoxide and isostearate zirconium butoxide.

Examples of the titanium chelate compounds include tetraisopropyl titanate, tetranormalbutyl titanate, butyl titanate dimer, tetra(2-ethylhexyl)titanate, titanium acetyl acetonate, polytitanium acetylacetonate, titanium octylene glycolate, titanium lactate ammonium salt, titanium lactate, titanium lactate ethyl ester, titanium triethanol aminate and polyhydroxy titanium stearate.

Examples of the aluminum chelate compounds include aluminum isopropylate, monobutoxy aluminum diisopropylate, aluminum butylate, diethylacetoacetate aluminum diisopropylate and aluminum tris(ethylacetoacetate).

These compounds may be used alone, or as a mixture or a polycondensate of plural compounds.

The solvent for preparing the coating solution for forming an undercoating layer may appropriately be selected from known organic solvents such as alcohol solvents, aromatic solvents, hydrocarbon halide solvents, ketone solvents, ketone alcohol solvents, ether solvents and ester solvents. Examples thereof include common organic solvents such as methanol, ethanol, n-propanol, iso-propanol, n-butanol, benzyl alcohol, methyl cellosolve, ethyl cellosolve, acetone, methyl ethyl ketone, cyclohexanone, methyl acetate, ethyl acetate, n-butyl acetate, dioxane, tetrahydrofuran, methylene chloride, chloroform, chlorobenzene and toluene.

These solvents used for dispersion may be used alone or as a mixture of two or more kinds. When they are mixed, any mixed solvents which may solve a binder resin may be used.

As a method for dispersion, any of known methods including a roll mill, a ball mill, a vibration ball mill, an attritor, a sand mill, a colloid mill and a paint shaker may be used. For forming undercoating layer 1, any of conventional methods such as a blade coating method, a wire bar coating method, a spray coating method, a dip coating method, a bead coating method, an air knife coating method and a curtain coating method may be used.

Then, undercoating layer 1 is formed on the conductive substrate using the thus-obtained coating solution for forming an undercoating layer.

The Vickers hardness of undercoating layer 1 is preferably 35 or more.

Although the thickness of undercoating layer 1 may be optionally set to any thickness as long as desired characteristics is obtained, the thickness is preferably 15 μm or more, and more preferably from 15 μm to 50 μm.

When the thickness of undercoating layer 1 is less than 15 μm, sufficient antileak properties may not be obtained, while when the thickness is more than 50 μm, residual potential tends to remain during long-term use to cause defects in image density.

The surface roughness (ten point average roughness) of undercoating layer 1 is adjusted within the range of from ¼ n to ½X, when λ represents the wavelength of the laser for exposure used and n represents a refractive index of the upper layer, in order to prevent a moire image. Particles of a resin or the like may also be added to the undercoating layer for adjusting the surface roughness thereof. Examples of the resin particles include silicone resin particles and crosslinking PMMA resin particles.

The undercoating layer may be subjected to grinding for adjusting the surface roughness thereof. The method such as buffing, a sandblast treatment, a wet honing, a grinding treatment and the like may be used for grinding. The undercoating layer is obtained by drying the applied coating, which is usually carried out by evaporating the solvent at a temperature at which a film may be formed.

Charge Generating Layer

Charge generating layer 2 contains at least a charge generating material and a binding resin.

Examples of the charge generating material include azo pigments such as bisazo and trisazo pigments, condensed aromatic pigments such as dibromoantanthrone, perylene pigments, pyrrolopyrrole pigments, phthalocyanine pigments, zinc oxides and trigonal selenium. For laser exposure in the near-infrared region, preferable examples are metal or nonmetal phthalocyanine pigments, and more preferable are hydroxy gallium phthalocyanine disclosed in JP-A Nos. 5-263007 and 5-279591, chlorogallium phthalocyanine disclosed in JP-A No. 5-98181, dichlorotin phthalocyanine disclosed in JP-A Nos. 5-11172 and 5-11173, and titanyl phthalocyanine disclosed in JP-A Nos. 4-189873. For laser exposure in the near-ultraviolet region, preferable examples are condensed aromatic pigments such as dibromoantanthrone, thioindigo pigments, porphyrazine compounds, zinc oxides, trigonal selenium, and bisazo pigments disclosed in JP-A Nos. 2004-78147 and 2005-181992,

The binding resin used in charge generating layer 2 may be selected from a wide range of insulating resins, and from organic light conductive polymers such as poly-N-vinyl carbazole resins, polyvinyl anthracene resins, polyvinyl pyrene resins and polysilane resins. Preferable examples of the binding resin include polyvinyl butyral resins, polyarylate resins (e.g., polycondensates of bisphenols and aromatic divalent carboxylic acid or the like), polycarbonate resins, polyester resins, phenoxy resins, vinyl chloride-vinyl acetate copolymers resins, polyamide resins, acrylic resins, polyacrylamide resins, polyvinyl pyridine resins, cellulose resins, urethane resins, epoxy resins, casein, polyvinyl alcohol resins and polyvinyl pyrrolidone resins. These binding resins may be used alone or in combination of two or more kinds thereof. The mixing ratio between the charge generating material and the binding resin (charge generating material/binding resin) is preferably in the range of 10/1 to 1/10 by weight ratio.

Charge generating layer 2 may be formed using a coating solution in which the above-mentioned charge generating materials and binding resins are dispersed in a certain solvent.

Examples of the solvent used for dispersion include methanol, ethanol, n-propanol, n-butanol, benzyl alcohol, methyl cellosolve, ethyl cellosolve, acetone, methyl ethyl ketone, cyclohexanone, methyl acetate, n-butyl acetate, dioxane, tetrahydrofuran, methylene chloride, chloroform, chlorobenzene and toluene, which may be used alone or as a combination of two or more kinds.

For dispersing the charge generating materials and the binding resins in a solvent, any of conventional methods such as ball mill dispersion, attritor dispersion and sand mill dispersion may be used. By these dispersion methods, deformation of crystals of the charge generating material caused by dispersion may be prevented. The average particle diameter of the charge generating material to be dispersed is preferably 0.5 μm or less, more preferably 0.3 μm or less, and further preferably 0.15 μm or less.

For forming charge generating layer 2, any of conventional methods such as blade coating, Meyer bar coating, spray coating, dip coating, bead coating, air knife coating and curtain coating may be used.

The film thickness of the thus-obtained charge generating layer 2 is preferably from 0.1 μm to 5.0 μm and more preferably from 0.2 μm to 2.0 μm.

Image Forming Apparatus and Process Cartridge

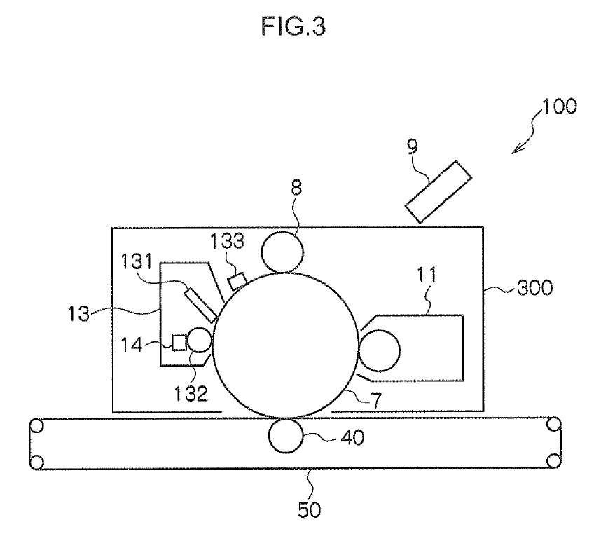

FIG. 3 is a schematic cross-sectional drawing which shows an exemplary embodiment of an image forming apparatus including an electrophotographic photoreceptor according to an exemplary embodiment of the invention. As shown in FIG. 3, the main body (not shown) of the image forming apparatus includes process cartridge 300, exposure device 9, transfer apparatus 40 and intermediate transfer medium 50, wherein process cartridge 300 includes electrophotographic photoreceptor 7. In image forming apparatus 100, exposure device 9 is arranged so as to irradiate electrophotographic photoreceptor 7 through the opening of process cartridge 300, and intermediate transfer medium 50 is arranged so as to partially contact with electrophotographic photoreceptor 7.

Process cartridge 300 shown in FIG. 3 integrally has electrophotographic photoreceptor 7, charger 8, developing device 11 and cleaning device 13 in a housing. Cleaning device 13 has at least cleaning blade 131, and cleaning blade 131 is disposed so as to contact the surface of electrophotographic photoreceptor 7.

FIG. 3 shows an example of cleaning device 13 using fibrous member 132 (roll-shaped) for supplying lubricant 14 to the surface of photoreceptor 7 and fibrous member 133 for assisting cleaning (flat brush-shaped). Fibrous members 132 and 133 are used as necessary.

As charger 8, for example, a contact type charger including a conductive or semiconductive charging roller, a charging brush, a charging film, a charging rubber blade, a charging tube or the like may be used. Known chargers such as a non-contact type roller charger including a charging roller in the proximity of photoreceptor 7, and a scorotron or corotron charger utilizing corona discharge may also be used.

Examples of exposure device 9 include optical instruments which allows image-wise exposure of light of a semiconductor laser, an LED, a liquid-crystal shutter light or the like to the surface of photoreceptor 7. The wavelength of a light source to be used is in the range of the spectral sensitivity region of the photoreceptor. As the semiconductor laser light, near-infrared light having an oscillation wavelength in the vicinity of 780 nm is predominantly used. However, the wavelength of the light source is not limited to the above-mentioned wavelength, and lasers having an oscillation wavelength on the order of 600 nm and blue lasers having an oscillation wavelength at from 400 nm to 450 nm may also be used. Surface-emitting type laser light sources which are capable of multi-beam output are effective to form a color image.

As developing device 11, for example, a common developing device, in which a magnetic or non-magnetic one- or two-component developer is contacted or not contacted for developing may be used. Such developing device is not particularly limited as long as it has above-mentioned functions, and may be appropriately selected according to the purpose. Examples thereof include known developing devices in which the one- or two-component developer is applied to photoreceptor 7 using a brush or a roller.

A toner to be used in developing device 11 is described below.

The toner used in the image forming apparatus of the exemplary embodiment preferably has an average shape factor (ML²/A) of from 100 to 150, more preferably from 105 to 145, and further preferably from 110 to 140, in view of achieving high developability, high transferring property and high quality image. Furthermore, the volume-average particle diameter of the toner particles is preferably from 3 μm to 12 μm, more preferably 3.5 μm to 10 μm, and further preferably 4 μm to 9 p.m. By using toner particles which satisfy such average shape factor and volume-average particle diameter, developability and transferring property may be enhanced and a high quality image, so-called photographic image, may be obtained.

The toner is not particularly limited by a production method as long as it satisfies the above-mentioned average shape factor and volume-average particle diameter. Examples of the toner include those obtained by methods including a kneading and grinding method in which a binding resin, a coloring agent, a releasing agent, and optionally a charge control agent or the like are mixed and kneaded, ground, and classified; a method of changing the shape of the particles obtained by the kneading and grinding method, using mechanical shock or heat energy; an emulsion polymerization aggregation method in which a dispersion solution obtained by emulsion-polymerizing polymerizable monomers of a binding resin is mixed with a dispersion solution containing a coloring agent and a releasing agent, and optionally a charge control agent and other agents, then aggregated, heated and fused to obtain toner particles; a suspension polymerization method in which polymerizable monomers to obtain a binding resin and a solution containing a coloring agent, a releasing agent, and optionally a charge control agent, are suspended in an aqueous solvent and polymerized therein; and a dissolution-suspension method in which a binding resin and a solution containing a coloring agent, a releasing agent, and optionally a charge control agent and other agents, is suspended in an aqueous solvent to form particles.

Moreover, known methods may be used, such as a method of producing a toner having a core-shell structure in which aggregated particles are further attached to the toner obtained by the above-mentioned method, as a core, then heated and fused. As the method of producing the toner, a suspension-polymerization method, an emulsion polymerization aggregation method and a dissolution suspension method carried out in an aqueous solvent are preferable, and an emulsion polymerization aggregation method is most preferable, in view of controlling the shape and particle diameter distribution.

Toner mother particles include a binding resin, a coloring agent and a releasing agent, and as appropriate, further contain silica, a charge control agent, or the like.

Examples of the binding resins used in the toner mother particles include homopolymers and copolymers of styrenes such as styrene and chlorostyrene, monoolefins such as ethylene, propylene, butylene and isoprene, vinyl esters such as vinyl acetate, vinyl propionate, vinyl benzoate and vinyl butyrate, α-methylene aliphatic monocarboxylic acid esters such as methyl acrylate, ethyl acrylate, butyl acrylate, dodecyl acrylate, octyl acrylate, phenyl acrylate, methyl methacrylate, ethyl methacrylate, butyl methacrylate and dodecyl methacrylate, vinyl ethers such as vinyl methyl ether, vinyl ethyl ether and vinyl butyl ether, vinyl ketones such as vinyl methyl ketone, vinyl hexyl ketone and vinyl isopropenyl ketone, and polyester resins synthesized by copolymerization of dicarboxylic acids and dials.

Examples of specific typical binding resins include polystyrene, styrene-alkyl acrylate copolymer, styrene-alkyl methacrylate copolymer, styrene-acrylonitrile copolymer, styrene-butadiene copolymer, styrene-maleic anhydride copolymer, polyethylene, polypropylene and polyester resins. Other examples include polyurethane, epoxy resins, silicone resins, polyamide, modified rosin and paraffin wax.

Examples of the typical coloring agents may include magnetic powder such as magnetite and ferrite, carbon black, aniline blue, calco oil blue, chrome yellow, ultramarine blue, Du Pont oil red, quinoline yellow, methylene blue chloride, phthalocyanine blue, malachite green oxalate, lamp black, rose bengal, C. I. Pigment Red 48:1, C. I. Pigment Red 122, C. I. Pigment Red 57:1, C. I. Pigment Yellow 97, C. I. Pigment Yellow 17, C. I. Pigment Blue 15:1 and C. I. Pigment Blue 15:3.

Examples of the typical releasing agents may include low-molecular polyethylene, low-molecular polypropylene, Fischer-Tropsch wax, montan wax, carnauba wax, rice wax and candelilla wax.

As the charge control agent, any of known agents such as azo metal-complex compounds, metal-complex compounds of salicylic acid, and resin-type charge control agents having polar groups may be used. When a toner is produced by a wet method, materials hardly soluble in water may be used in view of controlling ion strength and reducing contamination by waste water. The toner may be either a magnetic toner which contains a magnetic material or a non-magnetic toner which contains no magnetic material.

The toner used in developing device 11 may be produced by mixing the above-mentioned toner mother particles and external additives using a Henschel mixer, a V blender or the like. When the toner mother particles are produced by a wet process, external additives may be added by a wet method.

Also, lubricant particles may be added to the toner used in developing device 11. Examples of the lubricant particles include solid lubricants including graphite, molybdenum disulfide, talc, fatty acids, metal salts of fatty acids or the like, low molecular weight polyolefins such as polypropylene, polyethylene and polybutene, fluorine-containing particles such as PTEF and PFA, silicones having a softening point when heated, fatty-acid amides such as oleic acid amide, erucic acid amide, ricinoleic acid amide and stearic acid amide, vegetable waxes such as carnauba wax, rice wax, candelilla wax, Japan wax and jojoba oil, animal waxes such as beeswax, mineral and petroleum waxes such as montan wax, ozokerite, ceresine, paraffin wax, microcrystalline wax and Fischer-Tropsch wax, and modified products thereof. These may be used alone or as a combination of two or more kinds. The average particle diameter of the lubricant particles is preferably in the range of from 0.1 μm to 10 μm, and those having the above-mentioned chemical structure may be ground into particles having the same particle diameter. The amount of the particles in the toner is preferably in the range of from 0.05% by weight to 2.0% by weight, more preferably from 0.1% by weight to 1.5% by weight.

Inorganic particles, organic particles, composite particles in which inorganic particles have been attached to the organic particles, or the like may be added to the toner used in developing device 11 for the purpose of removing a deposition or a deterioration-inducing substance from the surface of the electrophotographic photoreceptor.

Preferable examples of the appropriate inorganic particles include various inorganic oxides, nitrides and borides, such as silica, alumina, titania, zirconia, barium titanate, aluminum titanate, strontium titanate, magnesium titanate, zinc oxide, chromium oxide, cerium oxide, antimony oxide, tungsten oxide, tin oxide, tellurium oxide, manganese oxide, boron oxide, silicon carbide, boron carbide, titanium carbide, silicon nitride, titanium nitride and boron nitride.

The above-mentioned inorganic particles may be treated with a titanium coupling agent such as tetrabutyl titanate, tetraoetyl titanate, isopropyltriisostearoyl titanate, isopropyltridecylbenzenesulfonyl titanate or bis(dioctylpyrophosphate)oxyacetate titanate, or a silane coupling agent such as γ-(2-aminoethyl)aminopropyltrimethoxysilane, γ-(2-aminoethyl)aminopropylmethyldimethoxysilane, γ-methacryloxypropyltrimethoxysilane, N-β-(N-vinylbenzylaminoethyl)-γ-aminopropyltrimethoxysilane hydrochloride, hexamethyldisilazane, methyltrimethoxysilane, butyltrimethoxysilane, isobutyltrimethoxysilane, hexyltrimethoxysilane, octyltrimethoxysilane, decyltrimethoxysilane, dodecyltrimethoxysilane, phenyltrimethoxysilane, o-methylphenyltrimethoxysilane or p-methylphenyltrimethoxysilane. Furthermore, the above-mentioned particles may be hydrophilized with silicone oil, or metal salts of higher fatty acids such as aluminum stearate, zinc stearate and calcium stearate and may also be preferably used.

Examples of the organic particles which may be used include carbon fluoride in which fluorine is bound to black lead or graphite, polytetrafluoroethylene (PTFE) resin, perfluoroalkoxy-fluorine (PFA) resin, ethylene tetrafluoride-propylene hexafluoride (FEP) copolymer, ethylene-ethylene tetrafluoride (ETFE) copolymer, polychloroethylene trifluoride (PCTFE), polyvinylidene fluoride (PVDF) and polyvinyl fluoride (PVF).

The number average particle diameter is preferably from 5 nm to 1,000 nm, more preferably from 5 nm to 800 nm, and further preferably from 5 nm to 700 nm. When the average particle diameter is less than the lower limit, the particles tend to have insufficient abrasive properties. On the other hand, when the average particle diameter exceeds the upper limit, the particles tend to scratch the surface of the electrophotographic photoreceptor. The total amount of the above-mentioned particles and the lubricant particles is preferably 0.6% by weight or more.

As the other inorganic oxides added to the toner articles, small inorganic oxide particles having a primary diameter of 40 nm or less are preferably used in view of powder mobility and charge control, and inorganic oxide particles having a larger diameter than that of the small inorganic oxide particles are preferably added in view of adhesiveness reduction and charge control. Known inorganic oxide particles may be used, but combination use of silica and titanium oxide particles is preferable for precise charge control.

Surface treatment of small inorganic particles increases dispersibility and enhances the effect of increasing powder mobility. Furthermore, addition of a carbonate such as calcium carbonate or magnesium carbonate, or an inorganic mineral such as hydrotalcite or cerium oxide is also preferable to remove discharge products.

A color toner for electrophotography may be used in combination with a carrier. Examples of the carrier include iron powder, glass beads, ferrite powder, nickel powder and those carriers coated with a resin. The mixing ratio of the toner and carrier may be determined as appropriate.

Examples of transfer apparatus 40 include known transfer chargers such as a contact type transfer charger using a belt, a roller, a film, a rubber blade or the like, a scorotron transfer charger and a corotron transfer charger utilizing corona discharge.

As intermediate transfer body 50, a belt (intermediate transfer belt) to which semiconductivity is imparted and which is formed from of polyimide, polyamide imide, polycarbonate, polyarylate, polyester, rubber or the like is used. Besides the belt, intermediate transfer body 50 in the form of a drum may also be used.

In addition to the above-mentioned devices, the image forming apparatus may further include, for example, a photodischarge device that photodischarges photoreceptor 7.

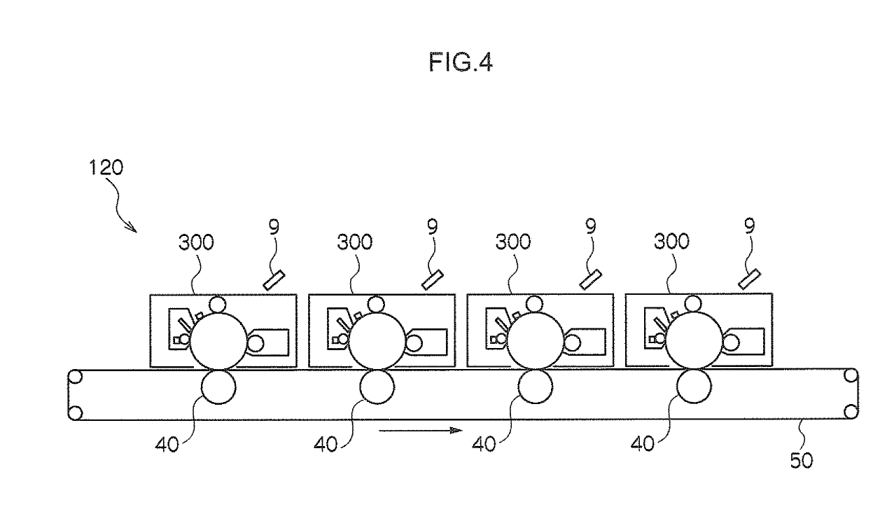

FIG. 4 is a schematic cross-sectional drawing showing an exemplary embodiment of a tandem-type image forming apparatus using a process cartridge including the electrophotographic photoreceptor of an exemplary embodiment of the invention.

Image forming apparatus 120 is a full color image forming apparatus of tandem type, including four process cartridges 300. In image forming apparatus 120, four process cartridges 300 are disposed parallel with each other on intermediate transfer body 50, and one electrophotographic photoreceptor is provided for one color. Image forming apparatus 120 has the same constitution as the image forming apparatus shown in FIG. 3, except being tandem type.

When the electrophotographic photoreceptor of the present exemplary embodiment is used in a tandem type image forming apparatus, the electrical characteristics of the four photoreceptors are stabilized, which provides high image quality with excellent color balance over a long time period.

### EXAMPLES

The invention will be described in more detail with reference to examples. However, the invention is not limited to the examples.

### Synthesis Example 1

### Synthesis of Compound IV-18

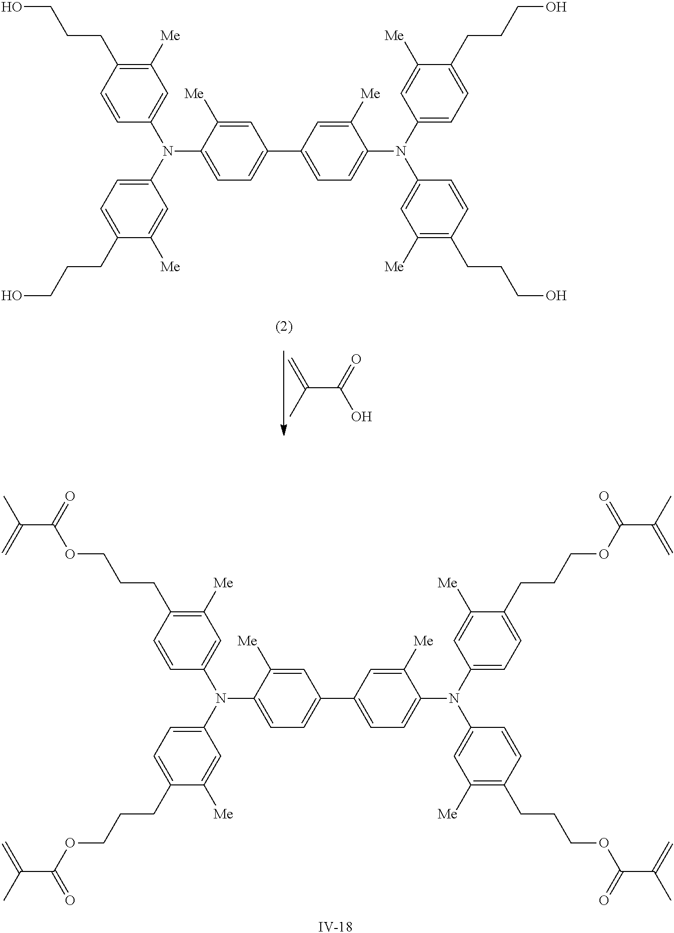

First, 50 g of the above-mentioned compound (2), 107 g of methacrylic acid, 300 ml of toluene and 2 g of p-toluenesulfonic acid are put into a 500 ml flask, and the mixture is heated under reflux for 10 hours. After the reaction, the product is cooled, poured into 2,000 ml of water for washing, and further washed with water. The resultant toluene phase is dried using anhydrous sodium sulfate and purified by silica gel column chromatography, thereby obtaining 38 g of Compound IV-18.

### Comparative Synthesis Example 1

First, 36 g of the above-mentioned compound (2), 70 g of acrylic acid, 300 ml of toluene and 2 g of p-toluenesulfonic acid are put into a 500 ml flask, and the mixture is heated under reflux for 10 hours. After the reaction, the product is cooled, poured into 2,000 ml of water for washing, and further washed with water. The resultant toluene phase is dried using anhydrous sodium sulfate and purified by silica gel column chromatography. However, gelation occurs during removal of the solvent by distillation under reduced pressure, and the objective product cannot be isolated.

### Comparative Synthesis Example 2

A reaction is carried out by adding 0.5 g of hydroquinone to Comparative Synthesis Example-1, and a treatment similar to that of Comparative Synthesis Example-1 is carried out. However, gelation occurs during removal of the solvent by distillation under reduced pressure, and the objective product cannot be isolated.

### Example 1

### Preparation of Undercoating Layer

First, 100 parts by weight of zinc oxide (average particle diameter: 70 nm, manufactured by Tayca Corporation, specific surface area: 15 m²/g) is stirred and mixed with 500 parts by weight of tetrahydrofuran, into which 1.3 parts by weight of a silane coupling agent (trade name: KBM503, manufactured by Shin-Etsu Chemical Co., Ltd.) is added and stirred for 2 hours. Subsequently, tetrahydrofuran is removed by distillation under reduced pressure, and baking is carried out at 120° C. for 3 hours, thereby obtaining zinc oxide whose surface has been treated with the silane coupling agent.

Next, 110 parts by weight of the surface-treated zinc oxide is stirred and mixed with 500 parts by weight of tetrahydrofuran, into which a solution in which 0.6 parts by weight of alizarin has been dissolved in 50 parts by weight of tetrahydrofuran is added, then stirred at 50° C. for 5 hours. Subsequently, the zinc oxide to which alizarin has been added is collected by filtration under a reduced pressure, and dried under reduced pressure at 60° C., thereby obtaining alizarin-added zinc oxide.

Then, 38 parts by weight of a solution prepared by dissolving 60 parts by weight of the alizarin-added zinc oxide, 13.5 parts by weight of a curing agent (blocked isocyanate, trade name: SUMIDUR 3175, manufactured by Sumitomo-Bayer Urethane Co., Ltd.) and 15 parts by weight of a butyral resin (trade name: S-LEC BM-1, manufactured by Sekisui Chemical Co., Ltd.) in 85 parts by weight of methyl ethyl ketone is mixed with 25 parts by weight of methyl ethyl ketone. The mixture is dispersed using a sand mill with the glass beads having a diameter of 1 mm for 2 hours to obtain a dispersion.

Subsequently, 0.005 parts by weight of dioctyltin dilaurate as a catalyst, and 40 parts by weight of silicone resin particles (trade name; TOSPEARL 145, manufactured by Momentive Performance Materials Inc.) are added to the obtained dispersion, thereby obtaining a coating solution for an undercoating layer. The coating solution is applied on an aluminum substrate having a diameter of 30 mm, a length of 340 mm and a thickness of 1 mm by dip coating, and cured by drying at 170° C. for 40 minutes, thereby forming an undercoating layer having a thickness of 18 μm.

### Preparation of Charge Generating Layer

A mixture including 15 parts by weight of hydroxy gallium phthalocyanine as a charge generating substance, 10 parts by weight of vinyl chloride-vinyl acetate copolymer resin (trade name: VMCH, manufactured by Nippon Unicar Co., Ltd.) as a binding resin, and 200 parts by weight of n-butyl acetate is dispersed using a sand mill with the glass beads of 1 mm diameter for 4 hours. The hydroxy gallium phthalocyanine has diffraction peaks at least at the positions of 7.3°, 16.0°, 24.9° and 28.0° of Bragg angles (2θ±0.2°) in an X-ray diffraction spectrum obtained with Cukα characteristic X-ray. Then, 175 parts by weight of n-butyl acetate and 180 parts by weight of methyl ethyl ketone are added to the resultant dispersion, and stirred to obtain a coating solution for a charge generating layer. The coating solution for charge generating layer is applied onto the undercoating layer by dip coating, and dried at an ordinary temperature, thereby forming a charge generating layer having a film thickness of 0.2 μm.

### Preparation of Charge Transporting Layer

Materials including a charge transporting material having polymerizable groups, a charge transporting material which does not have polymerizable groups, particles, a resin, a polymerization initiator and a solvent of the kinds and amounts shown in Tables 1 and 2 are mixed to prepare a coating liquid. The coating liquid is applied onto the charge generating layer by dip coating method, and dried for 30 minutes at room temperature.

The photoreceptor is then heated under nitrogen atmosphere under the heating conditions as shown in Table 2 for polymerization, thereby producing a photoreceptor. The film thickness of the charge transporting layer of the thus-obtained photoreceptor is 35 μm.

### Example 2

The undercoating layer and charge generating layer are prepared in the same manner as in Example 1.

### Preparation of Non-Crosslinkable Charge Transporting Layer

First, 4.5 parts by weight of N,N′-diphenyl-N,N′-bis(3-methylphenyl)-[1,1′]-biphenyl-4,4′-diamine and 5.5 parts by weight of bisphenol Z polycarbonate resin (viscosity average molecular weight: 40,000) are dissolved in 80 parts by weight of chlorobenzene to obtain a coating liquid for a charge transporting layer. The coating liquid is applied onto the charge generating layer by dip coating, and dried at 130° C. for 45 minutes. The film thickness of the resultant non-crosslinkable charge transporting layer is 20 μm.

### Preparation of Charge Transporting Layer (Outermost Layer)

Materials including a charge transporting material having polymerizable groups, a charge transporting material which does not have polymerizable groups, particles, a binding resin, a polymerization initiator and a solvent of the kinds and amounts shown in Tables 1 and 2 are mixed to prepare a coating liquid. The coating liquid is applied onto the non-crosslinkable charge generating layer by dip coating, and dried for 30 minutes at room temperature.

The photoreceptor is then heated under nitrogen atmosphere under the heating conditions shown in Table 2 for polymerization, thereby producing a photoreceptor. The film thickness of the charge transporting layer of the thus-obtained photoreceptor is 40 μm.

### Examples 3 to 11

The photoreceptors of Examples 3 to 11 are prepared in the same manner as in Example 1 except that the kinds and amounts of the materials including the charge transporting material having polymerizable groups, charge transporting material which does not have polymerizable groups, particles, binding resin, polymerization initiator and solvent, the heating conditions, and the presence or absence of the other non-crosslinkable type charge transporting layer are changed as shown in Tables 1 and 2.

### Comparative Examples 1 to 3

The photoreceptors of Comparative Examples 3 to 11 are prepared in the same manner as in Example 1 except that the kinds and amounts of the materials including the charge transporting material having polymerizable groups, charge transporting material which does not have polymerizable groups, particles, binding resin, polymerization initiator and solvent, the heating conditions, and the presence or absence of the other non-crosslinkable type charge transporting layer are changed as shown in Tables 3 and 4.

TABLE 1

| | Charge transporting layer (outermost layer) | | | | | | | |
|---|---|---|---|---|---|---|---|---|
| | | Charge | | | | | | |
| | Charge | transporting | | | | | | |
| | transporting | material which | | | | | | |
| | material having | does not have | | | | Polymerization initiator | | |
| | polymerizable | polymerizable | | | | | Decomposition | Half-life |
| | groups | groups | Particles | Resin | Antioxidant | | temperature | temperature |
| Example | IV-18 | CTM-1 | PL-1 | Resin 1 | Antioxidant 1 | Catalyst 1 | 90° C. | 51° C. |
| 1 | 70 parts | 30 parts | 3 parts | 20 parts | 1 part | 1.6 parts | | |
| | by weight | by weight | by weight | by weight | by weight | by weight | | |
| Example | IV-15 | CTM-1 | S-1 | Resin 2 | Antioxidant 1 | Catalyst 1 | 90° C. | 51° C. |
| 2 | 75 parts | 25 parts | 3 parts | 20 parts | 1 part | 1.6 parts | | |
| | by weight | by weight | by weight | by weight | by weight | by weight | | |
| Example | IV-9 | CTM-1 | PTFE | Resin 3 | Antioxidant 2 | Catalyst 1 | 90° C. | 51° C. |
| 3 | 80 parts | 20 parts | 3 parts | 20 parts | 1 part | 1.6 parts | | |
| | by weight | by weight | by weight | by weight | by weight | by weight | | |
| Example | IV-18 | CTM-1 | PL-1 | Resin 3 | Antioxidant 1 | Catalyst 1 | 90° C. | 51° C. |
| 4 | 70 parts | 30 parts | 3 parts | 30 parts | 1 part | 1.6 parts | | |
| | by weight | by weight | by weight | by weight | by weight | by weight | | |
| Example | IV-21 | CTM-1 | PL-1 | Resin 2 | Antioxidant 1 | Catalyst 2 | 115° C. | 61° C. |
| 5 | 80 parts | 20 parts | 3 parts | 20 parts | 1 part | 1.6 parts | | |
| | by weight | by weight | by weight | by weight | by weight | by weight | | |
| Examnle | IV-20 | CTM-1 | S-1 | Resin 1 | Antioxidant 2 | Catalyst 2 | 115° C. | 61° C. |
| 6 | 75 parts | 25 parts | 3 parts | 20 parts | 1 part | 1.6 parts | | |
| | by weight | by weight | by weight | by weight | by weight | by weight | | |
| Example | III-1 | CTM-1 | S-1 | Resin 3 | Antioxidant 2 | Catalyst 1 | 90° C. | 51° C. |
| 7 | 65 parts | 35 parts | 3 parts | 30 parts | 1 part | 1.6 parts | | |
| | by weight | by weight | by weight | by weight | by weight | by weight | | |
| Example | III-1 | CTM- 1 | PL-1 | Resin 1 | Antioxidant 1 | Catalyst 2 | 115° C. | 61° C. |
| 8 | 75 parts | 25 parts | 3 parts | 20 parts | 1 part | 1.6 parts | | |
| | by weight | by weight | by weight | by weight | by weight | by weight | | |
| Example | III-1 | CTM-1 | PL-1 | Resin 3 | Antioxidant 2 | Catalyst 2 | 115° C. | 61° C. |
| 9 | 80 parts | 20 parts | 3 parts | 20 parts | 1 part | 1.6 parts | | |
| | by weight | by weight | by weight | by weight | by weight | by weight | | |
| Example | II-20 | CTM-1 | PL-1 | Resin 2 | Antioxidant 1 | Catalyst 1 | 90° C. | 51° C. |
| 10 | 75 parts | 25 parts | 3 parts | 20 parts | 1 part | 1.6 parts | | |
| | by weight | by weight | by weight | by weight | by weight | by weight | | |
| Example | IV-18: 40 parts | CTM-1 | PL-1 | Resin 1 | Antioxidant 2 | Catalyst 2 | 115° C. | 61° C. |
| 11 | by weight | 20 parts | 3 parts | 20 parts | 1 part | 1.6 parts | | |
| | I-11: 40 parts | by weight | by weight | by weight | by weight | by weight | | |
| | by weight | | | | | | | |

TABLE 2

| | Charge transporting layer (outermost layer) | | | | Other non- | Amount of |
|---|---|---|---|---|---|---|
| | Solvent having boiling point of from 150° C. to 250° C. | | Other | Heating | crosslinkable charge | residual organic |
| | Kind | Boiling point (° C.) | solvent | condition | transporting layer | solvent (ppm) |
| Example 1 | Methylcyclohexanone: | 170 | THF: 50 parts | 160° C. | Not used | 10000 |
| | 50 parts by weight | | by weight | 60 minutes | | |
| Example 2 | Cyclohexanol: | 161 | THF: 50 parts | 180° C. | Used | 7500 |
| | 50 parts by weight | | by weight | 60 minutes | | |
| Example 3 | Methyl n-hexyl ether: | 173 | THF: 50 parts | 170° C. | Not used | 10500 |
| | 50 parts by weight | | by weight | 40 minutes | | |
| Example 4 | Diisobutylketone: | 168 | THF: 60 parts | 180° C. | Not used | 8000 |
| | 40 parts by weight | | by weight | 60 minutes | | |
| Example 5 | Diethylene glycol diethyl ether: | 188 | THF: 40 parts | 170° C. | Not used | 24000 |
| | 60 parts by weight | | by weight | 40 minutes | | |
| Example 6 | Butyl acetate: | 166 | THF: 70 parts | 180° C. | Not used | 6000 |
| | 30 parts by weight | | by weight | 60 minutes | | |
| Example 7 | Dibutyl oxalate: | 185 | THF: 50 parts | 170° C. | Not used | 21000 |
| | 50 parts by weight | | by weight | 40 minutes | | |
| Example 8 | Cyclohexyl acetate: | 174 | THF: 50 parts | 170° C. | Not used | 10000 |
| | 50 parts by weight | | by weight | 40 minutes | | |
| Example 9 | Diethylene glycol diethyl ether: | 230 | THF: 40 parts | 200° C. | Not used | 48000 |
| | 60 parts by weight | | by weight | 30 minutes | | |
| Example 10 | Cyclohexanol: | 161 | THF: 50 parts | 180° C. | Not used | 7000 |
| | 50 parts by weight | | by weight | 60 minutes | | |
| Example 11 | Methylcyclohexanone: | 170 | THF: 50 parts | 180° C. | Not used | 8500 |
| | 50 parts by weight | | by weight | 60 minutes | | |

TABLE 3

| | Charge transporting layer (outermost layer) | | | | | | | |
|---|---|---|---|---|---|---|---|---|
| | | Charge | | | | | | |
| | Charge | transporting | | | | | | |
| | transporting | material which | | | | | | |
| | material having | does not have | | | | Polymerization initiator | | |
| | polymerizable | polymerizable | | | | | Decomposition | Half-life |
| | groups | groups | Particles | Resin | Antioxidant | | temperature | temperature |
| Comparative | IV-15 | CTM-1 | PL-1 | Resin 1 | Antioxidant 1 | Catalyst 1 | 90° C. | 51° C. |
| Example 1 | 80 parts | 20 parts | 3 parts | 20 parts | 1 part | 1.6 parts | | |
| | by weight | by weight | by weight | by weight | by weight | by weight | | |
| Comparative | IV-7 | CTM-1 | PL-1 | Resin 1 | Antioxidant 1 | Catalyst 1 | 90° C. | 51° C. |
| Example 2 | 80 parts | 20 parts | 3 parts | 20 parts | 1 part | 1.6 parts | | |
| | by weight | by weight | by weight | by weight | by weight | by weight | | |
| Comparative | II-8 | — | PL-1 | Resin 1 | Antioxidant 1 | Catalyst 1 | 90° C. | 51° C. |
| Example 3 | 100 parts | | 3 parts | 20 parts | 1 part | 1.6 parts | | |
| | by weight | | by weight | by weight | by weight | by weight | | |

TABLE 4

| | Charge transporting layer (outermost layer) | | | | Other non- | Amount of |
|---|---|---|---|---|---|---|
| | Solvent having boiling point of from 150° C. to 250° C. | | Other | Heating | crosslinkable charge | residual organic |
| | Kind | Boiling point (° C.) | solvent | condition | transporting layer | solvent (ppm) |
| Comparative | Methylcyclohexanone: | 170 | THF: 80 parts | 130° C. | Not used | 60000 |
| Example 1 | 200 parts by weight | | by weight | 20 minutes | | |
| Comparative | Not used | Not used | THF: 40 parts | 145° C. | Not used | Detection limit |
| Example 2 | | | by weight | 60 minutes | | or less |
| | | | Tol: 60 parts | | | |
| | | | by weight | | | |
| Comparative | Not used | Not used | THF: 60 parts | 145° C. | Not used | Detection limit |
| Example 3 | | | by weight | 60 minutes | | or less |
| | | | Tol: 40 parts | | | |
| | | | by weight | | | |

Resin 1: polyvinylphenol resin (weight average molecule weight 8,000, manufactured by Aldrich)

Resin 2: butyral resin (trade name: S-LEC BM-1, manufactured by Sekisui Chemical Co., Ltd.)

Resin 3: bisphenol Z polycarbonate resin

Non-crosslinkable charge transporting material: N,N′-diphenyl-N,N′-bis(3-methylphenyl)-[1,1′]-biphenyl-4,4′-diamine (CTM-1)

Particles: PL-1 (trade name, manufactured by Fuso Chemical Co., Ltd.)

Particles: S-1 (trade name, manufactured by Titan Kogyo Ltd.)

Particles: PTFE (trade name: LUBRON L-2, manufactured by Daikin Industries Ltd.)

Inhibitor 1: BHT (Dibutylhydroxytoluene)

Inhibitor 2: SANOL LS770(trade names, manufactured by Sankyo Lifetech Co., Ltd.)

Catalyst 1: V-65 (decomposition temperature: 90° C., 10 hours half-life temperature: 51° C.)

Catalyst 2: OTAZO-15 (decomposition temperature: 115° C., 10 hours half-life temperature: 61° C.)

Other solvent THF: tetrahydrofuran (boiling point 66° C.)

Other solvent Tot: toluene (boiling point 110.6° C.)

Method for Evaluating Photoreceptor

### Evaluation of Printing Obtained Using Photoreceptor

After temperature profiling, the electrophotographic photoreceptor is mounted on DOCUCENTRE COLOR 400CP manufactured by Fuji Xerox Co., Ltd., and subjected to the following evaluations.

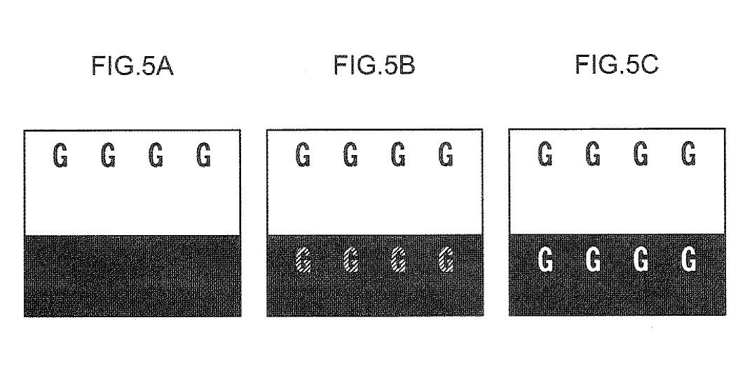

First, an image evaluation pattern as shown in FIG. 5A is output under a low temperature and a low humidity (18° C., 20% RH) and used as Evaluation image 1. Subsequently, black-solid patterns are output continuously on 10,000 sheets, then an image evaluation pattern is output and used as Evaluation image 2. After the photoreceptor is left for 24 hours in an environment under a low temperature and a low humidity (18° C., 20% RH), an image evaluation pattern is output and used as Evaluation image 3. Black-solid patterns are output on 10,000 sheets in an environment under a high humidity (28° C., 60% RH), then an image evaluation pattern is output and used as Evaluation image 4. After the photoreceptor is left for 24 hours in the environment under a high humidity (28° C., 60% RH), an image evaluation pattern is output and used as Evaluation image 5. The environment is returned to a low temperature and a low humidity (18° C., 20% RH) again, black-solid patterns are further output on 30,000 sheets, and an image evaluation pattern is output and used as Evaluation image 6.

### Ghost Image Evaluation

In the ghost image evaluation, Evaluation images 3 and 5 are respectively compared to Evaluation images 2 and 4, and the degree of deterioration of image quality is visually evaluated.

A+: Good, generation of a ghost image is not observed as shown in FIG. 5A,

A: Good as in FIG. 5A, but a ghost image is slightly generated.

B: A ghost image stands out slightly as shown in FIG. 5B.

C: A ghost image is clearly visible as shown in FIG. 5C.

Fogging Evaluation

In the fogging evaluation, Evaluation image 6 is compared to Evaluation images 1 to 5, and the degree of adhesion of the toner to the white background is visually observed.

A+: Very fine.

A: Fine.

B: Slight fogging is observed.

C: Fogging which causes problems on image quality is observed.

Streak Evaluation

In the streak evaluation, Evaluation image 6 is compared to Evaluation images 1 to 5, and the degree of generation of streaks is visually observed.

A: Fine.

B: Streaks are partially observed.

C: Streaks which cause problems on image quality are observed.

The results are summarized in Table 5.

TABLE 5

| | Ghost | Fogging | Streaks |
|---|---|---|---|
| Example 1 | A+ | A | A |
| Example 2 | A | A+ | A |
| Example 3 | A+ | A | A |
| Example 4 | B | A | A |
| Example 5 | A+ | A | A |
| Example 6 | A | A | A |
| Example 7 | A+ | A | B |
| Example 8 | A | A | B |
| Example 9 | B | B | B |
| Example 10 | B | B | B |
| Example 11 | B | B | B |
| Comparative Example 1 | C | B | B |
| Comparative Example 2 | C | C | C |
| Comparative Example 3 | C | B | C |

Exemplary embodiments of the invention and effects thereof are described below.

<1> An electrophotographic photoreceptor comprising an electroconductive substrate and a photosensitive layer formed thereon,

the photosensitive layer comprising a sub-layer that constitutes an outermost surface of the photosensitive layer,

the sub-layer comprising an organic solvent having a boiling point of from about 65° C. to about 250° C. in an amount of from about 5,000 ppm to about 50,000 ppm, and

the sub-layer comprising a polymer of a charge transporting material having a polymerizable group.

<2> The electrophotographic photoreceptor of <1>, wherein the amount of the organic solvent is from about 5,000 ppm to about 25,000 ppm.

<3> The electrophotographic photoreceptor of <1>, wherein the amount of the organic solvent is from about 10,000 ppm to about 25,000 ppm.

<4> The electrophotographic photoreceptor of <1>, wherein the boiling point of the organic solvent is from about 150° C. to about 250° C.

<5> The electrophotographic photoreceptor of <1>, wherein the boiling point of the organic solvent is from about 160° C. to about 230° C.

<6> The electrophotographic photoreceptor of <1>, wherein:

the sub-layer that constitutes the outermost surface of the photosensitive layer further comprises a polymerization initiator; and

the boiling point of the organic solvent is higher than a decomposition temperature of the polymerization initiator, and the difference between the boiling point of the organic solvent and the decomposition temperature of the polymerization initiator is more than about 0° C. and about 125° C. or less.

<7> The electrophotographic photoreceptor of <1>, wherein the number of the polymerizable groups included in the charge transporting material is two or more.

<8> The electrophotographic photoreceptor of <1>, wherein the organic solvent is at least one selected from the group consisting of cyclohexanone, methyl-n-hexyl ether, diisobutylketone, methylcyclohexanone, diethylene glycol diethyl ether, butyl acetate, dibutyl oxalate and cyclohexyl acetate.

<9> The electrophotographic photoreceptor of <1>, wherein the charge transporting material is at least one selected from the group consisting of compounds represented by the following Formula (A):

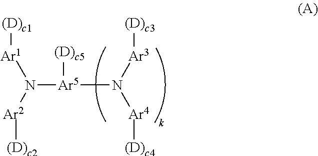

wherein, in Formula (A), Ar¹ to Ar⁴ each independently represent a substituted or unsubstituted awl group; Ar⁵ represents a substituted or unsubstituted aryl group or a substituted or unsubstituted arylene group; D represents —(CH₂)_{d}—(O—(CH₂)_{f})ₑ—O—CO—C(R′)═CH₂; R′ represents a hydrogen atom or —CH₃; c1 to c5 each independently represent an integer of from 0 to 2; k represents 0 or 1; d represents an integer of from 0 to 5; f represents an integer of from 1 to 5; e represents 0 or 1; and the total number of the groups represented by D is 2 or more.

<10> A method for producing an electrophotographic photoreceptor comprising:

forming a photosensitive layer on an electroconductive substrate, the forming of the photosensitive layer comprising forming a sub-layer, which constitutes an outermost surface of the photosensitive layer, by subjecting a solution comprising at least an organic solvent having a boiling point of from about 65° C. to about 250° C. and a charge transporting material having a polymerizable group to heat polymerization at a temperature within 30° C. of the boiling point of the organic solvent.

<11> The method for producing an electrophotographic photoreceptor of <10>, wherein the solution further comprises a heat polymerization initiator and a temperature at which an amount of the solution decreases by half after being left for 10 hours is from about 10° C. to about 100° C.

<12> The method for producing an electrophotographic photoreceptor of <10>, wherein the heat polymerization is carried out at a temperature of about 160° C. or more.

<13> A process cartridge which is attachable to and detachable from an image forming apparatus, the process cartridge comprising:

the electrophotographic photoreceptor of <1>; and

at least one apparatus selected from the group consisting of a charger that charges the electrophotographic photoreceptor, a developing apparatus that develops an electrostatic latent image formed on the electrophotographic photoreceptor with a toner, and a toner removal apparatus that removes the toner remaining on a surface of the electrophotographic photoreceptor.

<14> An image forming apparatus comprising:

the electrophotographic photoreceptor of <1>;

a charger that charges the electrophotographic photoreceptor;

an electrostatic latent image forming apparatus that forms an electrostatic latent image on the charged electrophotographic photoreceptor;

a developing apparatus that forms a toner image by developing the electrostatic latent image formed on the electrophotographic photoreceptor with a toner; and

a transfer apparatus that transfers the toner image to an image receiving body.

The foregoing description of the exemplary embodiments of the present invention has been provided for the purposes of illustration and description. It is not intended to be exhaustive or to limit the invention to the precise forms disclosed. Obviously, many modifications and variations will be apparent to practitioners skilled in the art. The embodiments were chosen and described in order to best explain the principles of the invention and its practical application, thereby enabling others skilled in the art to understand the invention for various embodiments and with the various modifications as are suited to the particular use contemplated. It is intended that the scope of the invention be defined by the following claims and their equivalents.

What is claimed is:

1. An electrophotographic photoreceptor comprising an electroconductive substrate and a photosensitive layer formed thereon,
the photosensitive layer comprising a sub-layer that constitutes an outermost surface of the photosensitive layer,
the sub-layer comprising an organic solvent having a boiling point of from about 65° C. to about 250° C. in an amount of from about 5,000 ppm to about 50,000 ppm, and
the sub-layer comprising a polymer of a charge transporting material having a polymerizable group.

2. The electrophotographic photoreceptor of claim 1, wherein the amount of the organic solvent is from about 5,000 ppm to about 25,000 ppm.

3. The electrophotographic photoreceptor of claim 1, wherein the amount of the organic solvent is from about 10,000 ppm to about 25,000 ppm.

4. The electrophotographic photoreceptor of claim 1, wherein the boiling point of the organic solvent is from about 150° C. to about 250° C.

5. The electrophotographic photoreceptor of claim 1, wherein the boiling point of the organic solvent is from about 160° C. to about 230° C.

6. The electrophotographic photoreceptor of claim 1, wherein:
the sub-layer that constitutes the outermost surface of the photosensitive layer further comprises a polymerization initiator; and
the boiling point of the organic solvent is higher than a decomposition temperature of the polymerization initiator, and the difference between the boiling point of the organic solvent and the decomposition temperature of the polymerization initiator is more than about 0° C. and about 125° C. or less.

7. The electrophotographic photoreceptor of claim 1, wherein the number of the polymerizable groups included in the charge transporting material is two or more.

8. The electrophotographic photoreceptor of claim 1, wherein the organic solvent is at least one selected from the group consisting of cyclohexanone, methyl-n-hexyl ether, diisobutylketone, methylcyclohexanone, diethylene glycol diethyl ether, butyl acetate, dibutyl oxalate and cyclohexyl acetate.

9. The electrophotographic photoreceptor of claim 1, wherein the charge transporting material is at least one selected from the group consisting of compounds represented by the following Formula (A): 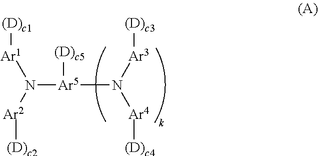
wherein, in Formula (A), Ar¹ to Ar⁴ each independently represent a substituted or unsubstituted aryl group; Ar⁵ represents a substituted or unsubstituted aryl group or a substituted or unsubstituted arylene group; D represents —(CH₂)_{d}—(O—(CH₂)_{f})ₑ—O—CO—C(R′)═CH₂; R′ represents a hydrogen atom or —CH₃; c1 to c5 each independently represent an integer of from 0 to 2; k represents 0 or 1; d represents an integer of from 0 to 5; f represents an integer of from 1 to 5; e represents 0 or 1; and the total number of the groups represented by D is 2 or more.

10. A method for producing an electrophotographic photoreceptor comprising:
forming a photosensitive layer on an electroconductive substrate, the forming of the photosensitive layer comprising forming a sub-layer, which constitutes an outermost surface of the photosensitive layer, by subjecting a solution comprising at least an organic solvent having a boiling point of from about 65° C. to about 250° C. and a charge transporting material having a polymerizable group to heat polymerization at a temperature within 30° C. of the boiling point of the organic solvent.

11. The method for producing an electrophotographic photoreceptor of claim 10, wherein the solution further comprises a heat polymerization initiator and a temperature at which an amount of the heat polymerization initiator decreases by half after being left for 10 hours is from about 10° C. to about 100° C.

12. The method for producing an electrophotographic photoreceptor of claim 10, wherein the heat polymerization is carried out at a temperature of about 160° C. or more.

13. A process cartridge which is attachable to and detachable from an image forming apparatus, the process cartridge comprising:
the electrophotographic photoreceptor of claim 1; and
at least one apparatus selected from the group consisting of a charger that charges the electrophotographic photoreceptor, a developing apparatus that develops an electrostatic latent image formed on the electrophotographic photoreceptor with a toner, and a toner removal apparatus that removes the toner remaining on a surface of the electrophotographic photoreceptor.

14. An image forming apparatus comprising:
the electrophotographic photoreceptor of claim 1;
a charger that charges the electrophotographic photoreceptor;
an electrostatic latent image forming apparatus that forms an electrostatic latent image on the charged electrophotographic photoreceptor;
a developing apparatus that forms a toner image by developing the electrostatic latent image formed on the electrophotographic photoreceptor with a toner; and
a transfer apparatus that transfers the toner image to an image receiving body.
